(19) United States
(12) Patent Application Publication
(10) Pub. No.: US 2025/0245055 A1
(43) Pub. Date: Jul. 31, 2025

(54) Automated Retries for Orchestration of a Datacenter on a Cloud Platform

(71) Applicant: Salesforce, Inc., San Francisco, CA (US)

(72) Inventors: Zemann Phoesop Sheen, San Francisco, CA (US); Christopher Steven Moyes, San Francisco, CA (US); Sreekanth Reddy Polaka, Aldie, VA (US); Abhishek B. Waichal, Oakland, CA (US)

(21) Appl. No.: 18/428,012

(22) Filed: Jan. 31, 2024

(51) Int. Cl. G06F 9/50; G06F 11/14

(52) U.S. Cl. CPC G06F 9/5038; G06F 9/5072; G06F 11/1415

(57) ABSTRACT

Techniques are disclosed relating to implementing automated retries during orchestration of a datacenter on a cloud platform. Generating an orchestration workflow for the datacenter may include generating an aggregate pipeline for the orchestration. The aggregate pipeline includes instances of datacenter entity pipelines that include stages for provisioning and deployment of datacenter entities. The disclosed techniques include adding retry stages to the datacenter entity pipelines that are automatically invoked in the event of failure of a datacenter entity pipeline. The retry stages are placed at the end of individual datacenter entity pipelines and conditional expressions are included that invoke retry strategies defined by owners of the datacenter entity.

### BACKGROUND

### Technical Field

This disclosure relates generally to cloud computing systems and, more specifically, to implementing orchestration of datacenters on cloud platform infrastructures.

### Description of the Related Art

Many organizations are increasingly relying on cloud platforms (or cloud computing platforms) such as AWS (AMAZON WEB SERVICES), GOOGLE cloud platform, MICROSOFT AZURE, etc. for placement of infrastructure. Cloud platforms provide servers, storage, databases, networking, software, and other components over the internet to organizations. Conventionally, organizations maintain datacenters that house hardware and software used by the organization. However, maintaining datacenters can result in significant overhead in terms of maintenance, personnel, and infrastructure. As a result, organizations are shifting their datacenters to cloud platforms in order to provide scalability, elasticity, data residency, and agility for computing resources associated with the organizations.

A large system such as a multi-tenant system may manage services for a large number of organizations, which are tenants of the multi-tenant system and may interact with multiple cloud platforms. A multi-tenant system may have to maintain several thousand such datacenters on a cloud platform. Each datacenter may have different requirements for software releases. Furthermore, the software, languages, and features supported by each cloud platform may be different. For example, different cloud platforms may support different mechanisms for implementing network policies or access control. Furthermore, there is significant effort involved in the provisioning of resources (such as database/accounts/computing clusters) and deploying software in cloud platforms. Therefore, configuring a datacenter including multiple services on the cloud platform can be complex to achieve. Often the configuration involves manual steps and is prone to errors and security violations. Additionally, manual configurations and build may limit ability to parallelize functions and increase efficiency for build processes. These errors often lead to downtime. Such downtime for large systems such as multi-tenant systems may affect a very large number of users and cause significant disruption of services. Increased downtime may also reduce availability and slow commercialization.

### BRIEF DESCRIPTION OF THE DRAWINGS

FIG. 1 is a block diagram illustrating example elements of a system executing end-to-end orchestration of a datacenter on a cloud platform, according to some embodiments.

FIG. 2 is a block diagram illustrating example elements of an execution dependency module, according to some embodiments.

FIG. 3 is a block diagram illustrating example elements of an orchestration workflow execution module, according to some embodiments.

FIG. 4 is a flow diagram illustrating an example method relating to executing an end-to-end orchestration of a datacenter on a cloud platform, according to some embodiments.

FIG. 5 is a block diagram illustrating example elements of a system executing incremental orchestration for an existing datacenter on a cloud platform, according to some embodiments.

FIG. 6 is a block diagram illustrating example elements of another execution dependency module, according to some embodiments.

FIG. 7 is a block diagram illustrating example elements of another orchestration workflow execution module, according to some embodiments.

FIG. 8 is a flow diagram of an embodiment of a method for executing incremental orchestration for a datacenter on a cloud platform.

FIG. 9 is a block diagram illustrating example elements of a system implementing retries during execution of an orchestration workflow for a datacenter on a cloud platform, according to some embodiments.

FIG. 10 is a block diagram illustration of an example aggregate pipeline, according to some embodiments.

FIG. 11 is a block diagram illustration of an example service pipeline with a retry stage, according to some embodiments.

FIG. 12 is a flow diagram illustrating an example retry determination process for a retry stage in a service pipeline, according to some embodiments.

FIG. 13 is a flow diagram illustrating an example conditional expression evaluation process for individual stages in a service pipeline during a retry attempt, according to some embodiments.

FIG. 14 is a flow diagram of an embodiment of a method for implementing retry stages in an aggregate pipeline.

FIG. 15 is a block diagram of a system environment for a multi-tenant system with datacenters on cloud platforms, according to some embodiments.

FIG. 16 is a block diagram illustrating system architecture of a deployment module, according some embodiments.

FIG. 17 illustrates an example overall process for deploying software artifacts in a datacenter, according to some embodiments.

FIG. 18 is a block diagram of a software release management module, according to some embodiments.

FIG. 19 illustrates an example of a declarative specification of a datacenter, according to some embodiments.

FIG. 20 is a block diagram illustrating generation of datacenters on cloud platforms based on a platform independent declarative specification, according to some embodiments.

FIG. 21 shows an example datacenter configuration as specified using a declarative specification, according to some embodiments.

FIG. 22 shows an example aggregate pipeline generated for creating a datacenter based on a declarative specification, according to some embodiments.

FIG. 23 is a block diagram illustrating elements of a computer system for implementing various systems described in the present disclosure, according to some embodiments

### DETAILED DESCRIPTION

The present disclosure contemplates automated techniques for orchestration of datacenters on cloud platforms. Some of the disclosed techniques are implemented to enable end-to-end orchestration (e.g., build, destroy, update) of a datacenter on a cloud platform. Other disclosed techniques are directed to enabling incremental updating of services (e.g., build or destroy of services) on existing datacenters on cloud platforms. Yet further techniques are described for providing automation of retries during orchestration workflows, whether the orchestration workflow is for an end-to-end orchestration or an incremental update to an existing datacenter. As used herein, the term “datacenter” refers to a set of computing resources, which may include servers, applications, storage, memory, etc., that can be used by users (such as users associated with a tenant or enterprise). Cloud platforms are platforms available via a public network such as the internet that provide computing resources for one or more enterprises. Examples of computing resources provided by cloud platforms include, but are not limited to, storage, computational resources, applications, and databases. Cloud platforms allow enterprises to reduce upfront costs for setting up computing infrastructure while also allowing enterprises to get applications built and running more quickly and with less maintenance overhead after build. In some instances, implementation of computing resources on cloud platforms allows enterprises to adjust computing resources to changing demands, which may be rapidly fluctuating and unpredictable. Enterprises are able to create datacenters using computing resources of a cloud platform. In many current iterations, however, implementing a datacenter on each cloud platform requires expertise in the technology of the cloud platform.

In various embodiment, datacenters may be created in a cloud platform using a cloud platform infrastructure language that is cloud platform independent. For instance, a system (e.g., a computing system) may receive a declarative specification for a datacenter that is cloud platform independent. As used herein, the term “declarative specification” refers to a document or file that describes a structure of a datacenter to be implemented on a cloud platform. In various embodiments, the structure of a datacenter is describes as a hierarchy of datacenter entities. Datacenter entities may include, for example, one or more services, one or more additional datacenter entities, or combinations thereof. In various embodiments, the declarative specification may change with the addition or removal of services or datacenter entities (such as may happen when an update is orchestrated on a datacenter). In some embodiments, the declarative specification includes a description of the structure of the datacenter but does not provide any instructions specifying how to create the datacenter (e.g., the declarative specification is cloud platform independent). In certain embodiments, the cloud platform independent declarative specification is configured to generate the datacenter on any of a plurality of cloud platforms (e.g., various independent cloud platforms) and is specified using a cloud platform infrastructure language. Accordingly, the system receives information identifying a target cloud platform for creating the datacenter and may compile the cloud platform independent declarative specification to generate a cloud platform specific representation of the datacenter. The system sends the cloud platform specific datacenter representation and a set of instructions for execution of the datacenter on the target cloud platform. The target cloud platform then executes the instructions to configure the datacenter using the platform specific datacenter representation. In some embodiments, the system provides users with access to the computing resources of the datacenter configured by the cloud platform. An example of orchestration of a datacenter on a cloud platform is provided in U.S. Patent Publication No. 2023/0244463A1 to Dhruvakumar et al., which is incorporated by reference as if fully set forth herein.

In various embodiments, a system that receives a cloud platform independent declarative specification for creating a datacenter on a cloud platform may execute an orchestration workflow to build, destroy, or update the datacenter on the cloud platform. As used herein, the term “orchestration workflow” refers to a set or combination of various steps that are taken to generate and execute a set of pipelines for building, destroying, or updating a datacenter on a cloud platform. In various instances throughout this disclosure, the term “orchestration workflow” may be used interchangeably with the terms “orchestration of a datacenter” or “orchestration” with the verb “orchestrate” and its forms also being used in reference to an orchestration workflow. In some embodiments, an orchestration workflow may include generating an aggregate pipeline based on the declarative specification, generating an aggregate deployment version map, and executing the aggregate pipeline in conjunction with the aggregate deployment version map for orchestration of the datacenter. These steps in the orchestration workflow are further described herein. As used herein, the term “pipeline” refers to a set of instructions that describe actions that need to be performed for orchestration of the datacenter in terms of a sequence of stages to be executed. In some embodiments, pipelines include actions for creating datacenter entities of the datacenter.

An “aggregate pipeline” may be a collection of pipelines such as a hierarchy of pipelines. The hierarchy of pipelines in an aggregate pipeline may be determined according to the declarative specification. In certain embodiments, the aggregate pipeline is configured to create the datacenter. For instance, the system may generate an aggregate deployment version map associating datacenter entities of the datacenter with versions of software artifacts targeted for deployment on the datacenter entities. In various embodiments, the aggregate pipeline may be updated to reflect the addition or removal of services or datacenter entities that may occur when an update is orchestrated on a datacenter and based on changes in the declarative specification. The system may collect a set of software artifacts according to the aggregate deployment version map. In various embodiments, a software artifact is associated with a datacenter entity of the datacenter being created. For the orchestration workflow, the system may execute the aggregate pipeline in conjunction with the aggregate deployment version map to create the datacenter in accordance with the cloud platform independent declarative specification. Execution of the aggregate pipeline may include configuration of datacenter entities (e.g., services) based on the set of software artifacts. Deployment of artifacts in cloud platforms are described in U.S. Pat. No. 11,349,995 to Kiselev et al. and U.S. Pat. No. 11,277,303 to Srinivasan et al., each of which is hereby incorporated by reference by its entirety.

In various embodiments, as described above, the declarative specification for creating the datacenter is cloud platform independent (e.g., cloud platform agnostic). If operations related to a datacenter such as deployment of software releases, provisioning of resources, and so on are performed using conventional techniques, the user has to provide cloud platform specific instructions. Accordingly, the user needs expertise of the cloud platform being used. Furthermore, the instructions would be cloud platform specific and not be portable across multiple platforms. For example, the instructions for deploying software on an AWS cloud platform are different from instructions on a GCP cloud platform. As such, a developer would need to understand the details of how each feature is implemented on that specific cloud platform. The disclosed embodiments relate to a cloud platform infrastructure language that allows users to perform operations on datacenters using instructions that are cloud platform independent and can be executed on any cloud platform selected from a plurality of cloud platforms. For instance, a compiler of the cloud platform infrastructure language generates a cloud platform specific detailed instructions for a target cloud platform.

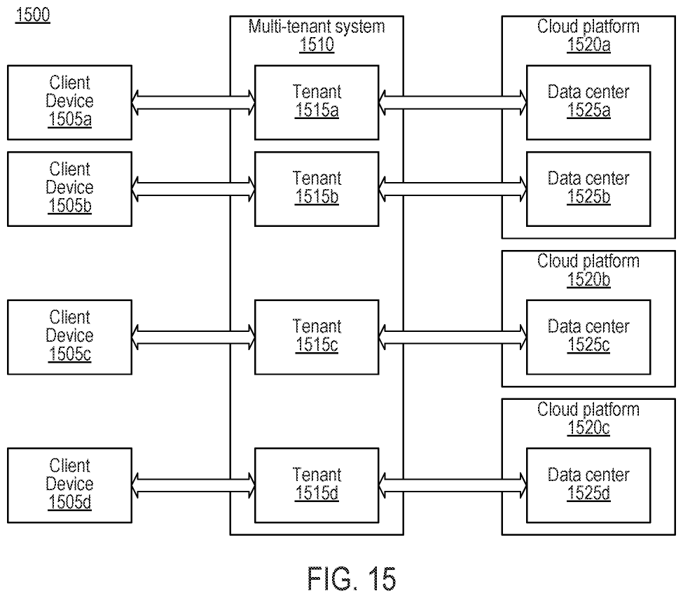

In various embodiments, a datacenter configured on a cloud platform may also be referred to as a virtual datacenter. Although embodiments are described for datacenters configured on a cloud platform (e.g., virtual datacenters), the techniques disclosed can be applied to physical datacenters as well. In various embodiments, the disclosed system may represent a multi-tenant system but is not limited to multi-tenant systems and can be any online system or any computing system with network access to the cloud platform. Further description of orchestration of a datacenter is provided by example below with reference to FIGS. 15-22 and Appendix A.

### End-to-End Orchestration

As may be readily noted from the embodiments of the orchestration of a datacenter herein along with the disclosure of U.S. Patent Publication No. 2023/0244463A1, there are many key activities that have to be performed before a cloud infrastructure orchestration can be initiated (e.g., an orchestration workflow can be initiated). For instance, particular datacenter entities (e.g., services) may be described in the declarative specification to have dependencies on one or more other datacenter entities. When a particular datacenter entity is dependent on other datacenter entities, the particular datacenter entity needs the other datacenter entities on which it depends to be running in order for the particular datacenter entity to be started (e.g., executed). Accordingly, in various embodiments, the datacenter entities that the particular datacenter entity is reliant may be referred to as “datacenter entity dependencies”. Dependency information may be determined from the declarative specification. For example, dependency information may be determined based on the hierarchy of datacenter entities indicated in the declarative specification.

In various embodiments, an orchestration workflow may have multiple steps or events that need to happen for the orchestration workflow to be able to continue and execute throughout a build/destroy/update process. These steps or events that need to happen may be referred to as “execution dependencies”. As used herein, the term “execution dependencies” refers to steps, events, or activities that need to be completed in order for an orchestration workflow associated with a datacenter to be executed. In some embodiments, execution dependencies are steps, events, or activities that datacenter entities that are part of the orchestration workflow need to be completed before the datacenter entity can be built, destroyed, or updated. In some instances, execution dependencies may be referred to as “external dependencies” as the steps, events, or activities are external to the orchestration workflow. Accordingly, for an entire orchestration workflow to be executed from start to finish (e.g., end-to-end), all executional dependencies need to be completed. Otherwise, some instances of datacenter entities or services cannot be orchestrated and the workflow will be interrupted. Examples of executional dependencies that may be need to be completed include, but are not limited to, metadata composition, public cloud account creation, and workflow manifestation. Metadata composition may be the generation of metadata for representing the datacenter entities. Public cloud account creation may be creation of an account associated with the datacenter entities of the start dependencies. Workflow manifestation may be, for example, the manifestation of workflows ordered by the start dependencies of datacenter entities and their corresponding entities that need to be deployed in the datacenter entities.

There are numerous amounts of these execution dependencies that need to be completed before an orchestration workflow can be fully executed from start to finish. Currently these activities are manually completed and an operator may have to manually check/wait for the activities to be completed. Manually waiting for activities to be completed may cause unnecessary wait times as well as opportunities for human error. Additionally, manual supervision may include multiple touchpoints that exist between different operators.

The present disclosure describes implementations of end-to-end (e.g., start to finish) orchestrations (either builds or destroys) where the system automatically checks for completion of the execution dependencies for datacenter entities specified in a declarative specification and then executes the orchestration workflow when it determines the execution dependencies have been completed. Completion of the execution dependencies allows for execution of datacenter entities in an orchestration workflow dependent on the execution dependencies. For instance, in certain embodiments, the system executes the orchestration workflow when it determines that all of the execution dependencies have been completed. The system may wait for all the execution dependencies to be completed to enable the orchestration workflow to be fully completed from end-to-end (e.g., start to finish) without interruption or arbitrarily waiting for execution dependencies to be completed.

In various embodiments, the system may determine completion of execution dependencies using techniques based on the types of execution dependencies being checked. For example, some execution dependencies may provide event completion notifications that are received by the system while other execution dependencies may be determined to be complete based on expiration of predetermined time periods for the activities. The predetermined time periods may be specified by a service level agreement (SLA) with the execution dependencies.

Having the system automatically check for completion of execution dependencies before execution of the orchestration workflow ensures that all the execution dependencies for datacenter entities in the orchestration workflow are in place before orchestration (e.g., build or destroy) of the datacenter is started by the system. Thus, a user/operator may initiate a datacenter orchestration (e.g., through an API interface or other technique) and then allow the system to execute the orchestration without further input from the user as the system itself waits to execute the orchestration workflow when it determines that all the execution dependencies (e.g., external dependencies) for datacenter entities in the orchestration workflow are completed. With the system itself waiting for completion of execution dependencies, the system implements an automated end-to-end orchestration for the datacenter. For instance, the user/operator provides an indication of what they want orchestrated (e.g., a build or destroy of a datacenter based on a declarative specification) and then the system determines execution dependencies associated with the datacenter entities in the declarative specification, initiates execution of those execution dependencies, and waits for completion of the execution dependencies before executing the orchestration workflow for the datacenter according to the declarative specification. This end-to-end orchestration process provides a more reliable and faster datacenter orchestration process than manually executed build or destroy processes.

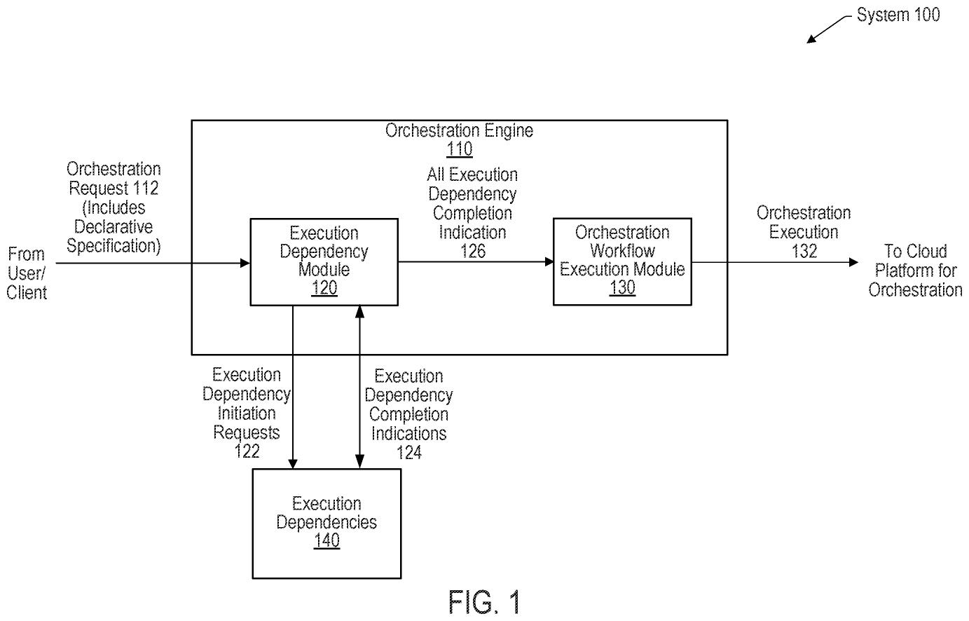

FIG. 1 is a block diagram illustrating example elements of a system executing end-to-end orchestration of a datacenter on a cloud platform, according to some embodiments. In the illustrated embodiment, orchestration engine 110 includes execution dependency module 120 and orchestration workflow execution module 130. Orchestration engine 110 may be a component in system 100. In some embodiments, system 100 may be a component in a computer system environment that also includes one or more cloud platforms and one or more client devices. In various embodiments, system 100 is a multi-tenant system operable to configure datacenters on the cloud platforms in the computer system. Tenants in system 100 may be enterprises or customers interacting with the system for utilization of datacenters on the cloud platforms. An example of a computer system environment with a multi-tenant system, cloud platforms, and client devices is shown and described below with reference to FIG. 15.

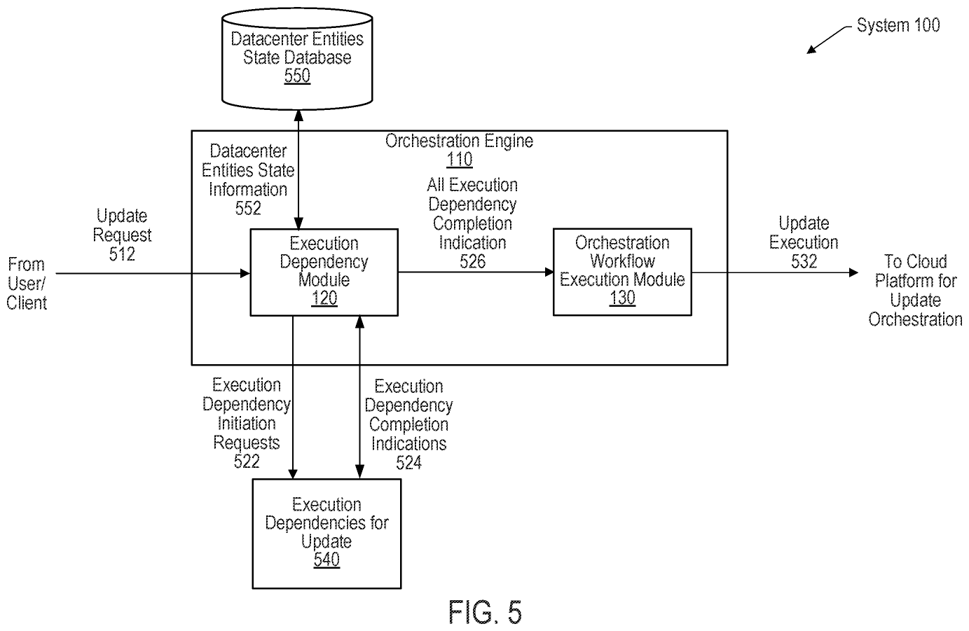

In various embodiments, orchestration engine 110 receives orchestration request 112 from a user or client of system 100. Orchestration request 112 may be a request to build, destroy, or update at least one datacenter on a cloud platform. In certain embodiments, request 112 specifies whether the request is a build or destroy request for a particular datacenter. Determination of whether the request is a new build of the particular datacenter, a complete destroy of the particular datacenter, or an update that builds or destroys one or more datacenter entities on the particular datacenter is described with respect to FIG. 5 below. The user or client making request 112 may be an operator (e.g., programmer) or an automated system making a request for orchestration of a datacenter on a cloud platform associated with system 100. In some embodiments, request 112 is received through a gateway (e.g., an orchestration gateway). The gateway may include authentication or authorization components to ensure the validity of request 112 and that only authenticated or authorized user/clients can trigger the datacenter orchestration. In one contemplated embodiment, request 112 is received through an application programming interface (API) associated with system 100 or the gateway to the system. The API may, for example, be in interface utilized by a customer of system 100.

In certain embodiments, request 112 includes a declarative specification. In some embodiments, request 112 includes other information in addition to the declarative specification. For example, request 112 may include service names, datacenter names, service groups, a release version of the declarative specification, and an indicator that a build, destroy, or update of the datacenter is being requested. In some embodiments, request 112 may include requests for multiple datacenter orchestrations. In such embodiments, the gateway may organize and determine targets for the orchestration requests.

As shown in FIG. 1, request 112 is received by execution dependency module 120 in orchestration engine 110. In certain embodiments, execution dependency module 120 determines execution dependencies for datacenter entities in the declarative specification. As described above, the execution dependencies are activities, steps, or events that need to be completed before orchestration of the datacenter entities in the declarative specification can be started/executed. Accordingly, when the execution dependencies are completed, the datacenter entities in the declarative specification are considered to be ready for orchestration and execution of the orchestration can be started.

In certain embodiments, execution dependency module 120 interfaces with execution dependencies 140 by providing execution dependency initiation requests 122 to the execution dependencies and assessing execution dependency completion indications 124 for the execution dependencies. Execution dependency initiation requests 122 to start execution dependencies 140 may be signals or other indicators that inform the execution dependencies to begin activities to get the execution dependencies up and running. In some embodiments, execution dependency initiation requests 122 may include other functions (exampled by SLA callback 252, described below). Execution dependency completion indications 124 may include indications informing execution dependency module 120 that execution dependencies 140 are completed. Thus, execution dependency module 120 may be capable of both initiating execution dependencies 140 and determining when the execution dependencies are completed. Execution dependency module 120 may send all execution dependency completion indication to orchestration workflow module 130 when all the execution dependencies for an orchestration are determined to be completed, as described herein.

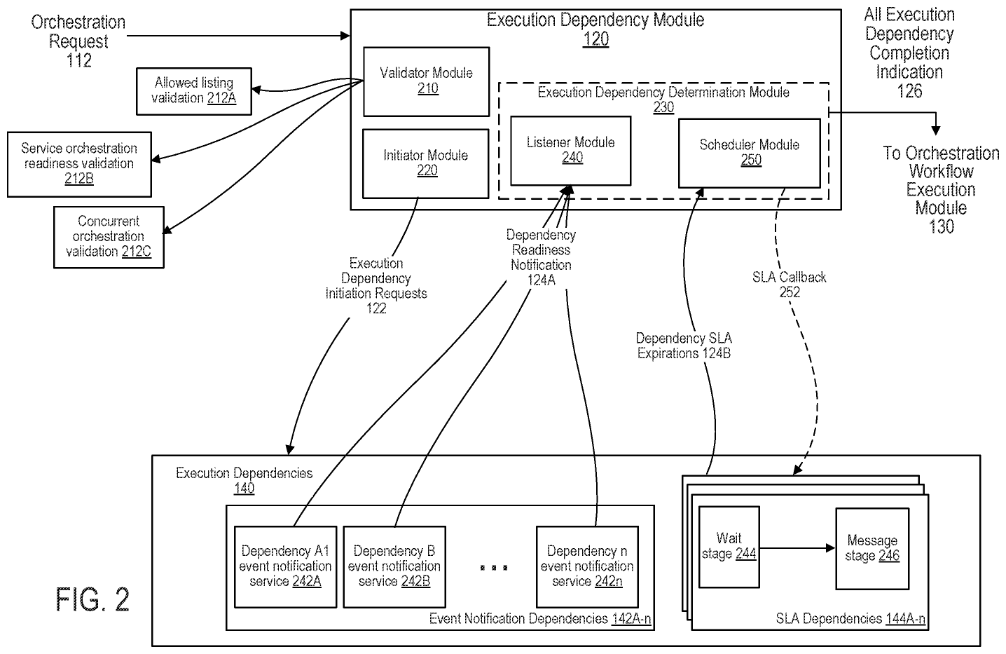

FIG. 2 is a block diagram illustrating example elements of execution dependency module 120, according to some embodiments. In the illustrated embodiment, execution dependency module 120 includes validation module 210, initiator module 220, and execution dependency determination module 230. In various embodiments, validator module 210 may perform various validations of aspects in orchestration request 112 (e.g., in the declarative specification of the request). Examples of possible validations include, but are not limited to, allowed (service) listing validation 212A, service orchestration readiness validation 212B, concurrent orchestration validation 212C, service state validation 212D, and dependency validation 212E. Allowed listing validation 212A may be a validation of services listed in the declarative specification being allowable services according to various policies or agreements (e.g., SLAs). Service orchestration readiness validation 212B may be a validation of the readiness for services involved in the orchestration and build of the datacenter. Concurrent orchestration validation 212C may be a validation of any concurrent orchestrations of datacenters and their impacts on the build in request 112.

In certain embodiments, as shown in FIG. 2, initiator module 220 provides execution dependency initiation requests 122 to execution dependencies 140. After execution dependency initiation requests 122 are provided to execution dependencies 140 by initiator module 220, execution dependency determination module 230 may determine when execution dependencies are completed. In various embodiments, execution dependency determination module 230 includes listener module 240 and scheduler module 250. Listener module 240 and scheduler module 250 may implement different mechanisms for determining whether execution dependencies 140 have been completed.

Some execution dependencies 140 may be event notification dependencies 142. Event notification dependencies 142 may be execution dependencies that include dependency event notification services 242, which are capable of notifying when steps, events, or activities associated with the execution dependency are completed. For event notification dependencies 142, listener module 240 may wait and “listen” for dependency readiness notifications 124A to be received from each of dependency event notification services 242A-n, where n is the total number of event notification dependencies 142A-n. Dependency readiness notifications 124A are a subset of execution dependency completion indications 124, shown in FIG. 1, associated with event notification dependencies 142. When a dependency readiness notification 124A that an execution dependency has completed is received, listener module 240 may set a status of the execution dependency as “NOTIFIED” OR “READY” for all the services (e.g., datacenter entities) that depend on the execution dependency.

In various embodiments, scheduler module 250 is implemented to handle execution dependencies that are subject to a service level agreement (SLA)—SLA dependencies 144. SLA dependencies 144A-n may have SLAs associated with them where the SLAs include predetermined time periods for the execution dependencies to be completed. When a predetermined time period for an SLA dependency 144 expires, scheduler module 250 determines dependency SLA expirations 124B for the SLA dependency, which indicates that the dependency may be considered to be completed. Dependency SLA expirations 124B are a subset of execution dependency completion indications 124, shown in FIG. 1, associated with SLA dependencies 144. It should be noted that event notification dependencies 142A-n may have corresponding SLA dependencies 144A-n. For instance, execution dependencies 140 may be both event notification dependencies and SLA dependencies. In some embodiments, the SLA dependency handled by scheduler module 250 for an execution dependency is invoked when an event notification is not received within the predetermined time period set by the SLA. To the contrary, if the event notification is received before the end of the predetermined time period, then the SLA action may be ignored by scheduler module 250.

In some embodiments, scheduler module 250 may implement an SLA callback function to determine when dependency SLA expirations 124B are issued. For example, scheduler module 250 may provide SLA callback 252 to SLA dependencies 144A-n. In various instances, SLA callback 252 is a function that may be implemented using managed workflow automation services such as Amazon (AWS) Step Functions. In some embodiments, SLA callback 252 may invoke task timers (such as step function task timers) in the SLA dependencies. Note that SLA callback 252 may be included in execution dependency initiation requests 122. In various embodiments, the task timer includes two components—wait stage 244 and message stage 246. Wait stage 244 may be a stage that waits for the expiration of the predetermined time period set by the SLA of the SLA dependency. At the end of the predetermine time period, message stage 246 may be invoked. Message stage 246 may include, for example, a managed messaging queuing service such as Amazon SQS (Simple Queue Service). Message stage 246 may provide a message back to scheduler module 250 (e.g., dependency SLA expiration 124B) to indicate that indicate that the SLA dependency is to be considered completed based on its SLA. In various embodiments, when scheduler module 250 determines that the predetermined time period of the SLA has expired, the scheduler module may set a status of the execution dependency to “SLA” or “READY” to indicate that the execution dependency is completed for all the services (e.g., datacenter entities) that depend on the execution dependency.

Once all the execution dependencies for a particular datacenter entity (e.g., particular service) have a status of “READY” (e.g., “NOTIFIED” or “SLA” via either event notification dependencies 142 or SLA dependencies 144), execution dependency determination module 230 may set the status of the particular datacenter entity to “READY TO ORCHESTRATE” or a similar state status. When all execution dependencies are determined to be completed, all the datacenter entities that are part of the orchestration workflow according to the declarative specification will have a “READY TO ORCHESTRATE” status. Having the statuses of execution dependencies automatically determined according to event notifications or expiration of SLAs eliminates the need for manual checking of the execution dependencies (e.g., manual callouts to the execution dependencies). At this point, all the execution dependencies are completed, which means that datacenter entities (e.g., services) that depend on the execution dependencies can all be started and the orchestration workflow can be executed. Accordingly, an orchestration process for the datacenter is ready to begin and execution dependency determination module 230 in execution dependency module 120 provides “all execution dependency completion indication 126” to orchestration workflow execution module 130, as shown in FIG. 1.

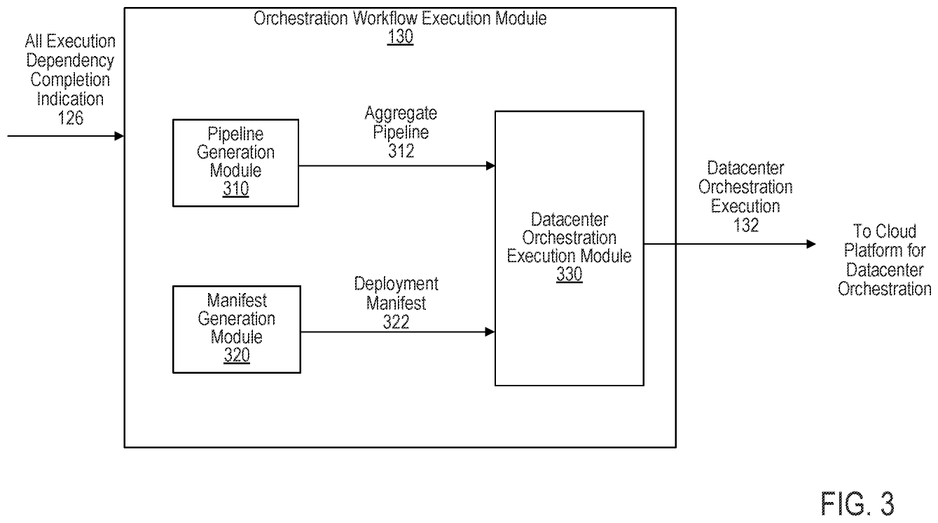

FIG. 3 is a block diagram illustrating example elements of orchestration workflow execution module 130, according to some embodiments. In the illustrated embodiment, orchestration workflow execution module 130 includes pipeline generation module 310, manifest generation module 320, and datacenter orchestration execution module 330. In various embodiments, pipeline generation module 310 generates an aggregate pipeline for creating the datacenter. An aggregate pipeline may include a hierarchy of smaller pipelines (such as service pipelines, service group pipelines, cell pipelines, etc.). Execution of the aggregate pipeline may be implemented to create datacenter entities (e.g., services) of the datacenter on the cloud platform. Service pipelines may include sequences of stages where each stage represents one or more actions that need to be performed by a cloud platform in order to provision and deploy the datacenter on the cloud platform.

In some embodiments, generating the pipelines includes collecting relevant metadata for orchestrating the pipelines and aggregate pipeline. For example, metadata for the various datacenter entities may be collected. The metadata may include, but not be limited to, layout information, dependency information, service attributes, or other information available from the declarative specification or agreements (e.g., SLAs) with the datacenter entities. Pipeline stages may then be setup based on the metadata and a final specification of the aggregate pipeline may be developed. Pipeline generation module 310 may output the specification of the aggregate pipeline as aggregate pipeline 312, as shown in FIG. 3.

In certain embodiments, manifest generation module 320 generates and outputs deployment manifest 322. In some embodiments, deployment manifest 322 may be referred to as an artifact version map, a software artifact version map, or a software release map. Deployment manifest 322 may include a description associating the datacenter entities of the yet to be deployed datacenter with versions of software artifacts (e.g., software releases) targeted for the deployment on the datacenter entities. Software artifacts may be associated with particular datacenter entities being created on the datacenter on a target cloud platform.

In various embodiments, aggregate pipeline 312 and deployment manifest 322 may be implemented by datacenter orchestration execution module 330 to provide instructions for datacenter orchestration execution 132. In some embodiments, datacenter orchestration execution 132 includes a cloud platform specific detailed pipeline, as described herein. Datacenter orchestration execution 132 may be provided to one or more cloud platforms for execution of the datacenter orchestration in the cloud platforms. In certain embodiments, datacenter orchestration execution 132 includes instructions for execution of aggregate pipeline 312 in conjunction with deployment manifest 322. As aggregate pipeline 312 is based on the declarative specification in request 112, shown in FIG. 1, the datacenter is built on the cloud platform according to the declarative specification with cloud platform specifics defined by deployment manifest 322. Further description and details of example embodiments for an execution of an orchestration workflow and a datacenter orchestration execution process are described in U.S. Patent Publication No. 2023/0244463A1 to Dhruvakumar et al. and in Appendix A below.

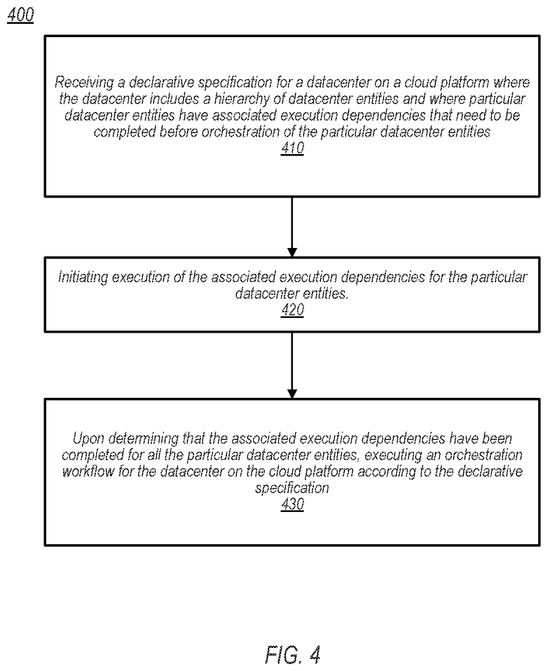

Proceeding now to FIG. 4, a flow diagram of an embodiment of a method for executing an end-to-end orchestration of a datacenter on a cloud platform is depicted. In various embodiments, method 400 may be performed by system 100, as shown in FIGS. 1-3. In some embodiments, system 100 may include (or have access to) a non-transitory, computer-readable medium having program instructions stored thereon that are executable by the system to cause the operations described with reference to FIG. 4.

At block 410, method 400 begins by receiving, at a computer system, a declarative specification for a datacenter on a cloud platform where the datacenter includes a hierarchy of datacenter entities and where particular datacenter entities have associated execution dependencies that need to be completed before orchestration of the particular datacenter entities.

Method 400 continues at block 420 by initiating execution of the associated execution dependencies for the particular datacenter entities.

At block 430, method 400 proceeds by, upon determining that the associated execution dependencies have been completed for all the particular datacenter entities, executing an orchestration workflow for the datacenter on the cloud platform according to the declarative specification.

### Incremental Orchestration

The embodiments described above with reference to FIGS. 1-4 provide techniques for implementing an end-to-end orchestration for a datacenter upon a request to build or destroy a datacenter. Various instances may be contemplated where a customer (e.g., user) makes a request that includes the addition or destruction of datacenter entities on an existing datacenter that has previously been built. The request may be made at any point during the lifetime of the datacenter (e.g., immediately after build or at some later point during its operation). Previous solutions typically required the datacenter to be updated manually. Manually updating a datacenter for the addition of even just a single datacenter entity (such as a service) may be time consuming, processor intensive, and cause undesirable downtime for the datacenter.

The present disclosure describes implementations of incremental updates to existing or previously built datacenters on cloud platforms. In various embodiments, an incremental update is to either add one or more datacenter entities (such as services) to an existing datacenter or remove (e.g., destroy) one or more existing datacenter entities from the existing datacenter. One of the techniques disclosed includes tracking the states of datacenter entities already in place on the existing datacenter. Tracking the states of the datacenter entities implemented enables the system to be capable of automatically: validating datacenter entities associated with the update request; determining execution dependencies associated with the datacenter entities in the update; determining completion of those execution dependencies only applicable to the update; and executing an orchestration workflow that invokes only pipelines needed for the update. In various embodiments, the system may initiate execution of these execution dependencies and wait for completion of the start execution dependencies before beginning the orchestration workflow to update the datacenter. Upon determining the execution dependencies have been completed, the system may execute the orchestration workflow to update the datacenter. In certain embodiments, the orchestration workflow includes execution of only the pipelines associated with the datacenter entities being added or removed. Executing only the pipelines for these datacenter entities shortens the time needed for the update to the datacenter, thereby reducing resource consumption for updating the datacenter. Waiting for all the execution dependencies to be completed before execution of the orchestration workflow for the datacenter update allows the update to be completed end-to-end without interruption or arbitrarily waiting for execution dependencies to be completed.

In various embodiments, as with the initial end-to-end orchestration, the system may determine completion of execution dependencies using techniques based on the types of dependencies being checked. For example, some execution dependencies may provide event completion notifications that are received by the system while other execution dependencies may be determined to be complete based on expiration of predetermined time periods for the execution dependencies. The predetermined time periods may be specified by a service level agreement (SLA) with the execution dependencies.

Having the system automatically check for completion of execution dependencies before execution of the orchestration workflow for the update ensures that all execution dependencies for the datacenter entities in the orchestration workflow are in place before updating the datacenter. Thus, a user/operator may request one or more datacenter entities to be updated (e.g., added or destroyed) on an existing datacenter (e.g., through an API interface or other technique) and then allow the system to execute the update without further input from the user as the system itself waits to execute the orchestration workflow when it determines that all the execution dependencies (e.g., external dependencies) for the update are completed and ready for execution in the orchestration workflow. With the system itself waiting for completion of execution dependencies, the system provides an automated incremental update on the existing datacenter.

FIG. 5 is a block diagram illustrating example elements of executing incremental orchestration for an existing datacenter on a cloud platform, according to some embodiments. In the illustrated embodiment, orchestration engine 110 includes execution dependency module 120 and orchestration workflow execution module 130, as previously described. In certain embodiments, system 100 includes datacenter entities state database 550. Datacenter entities state database 550 stores information associated with the tracking of states of every datacenter entity in a datacenter. Tracking of the states of datacenter entities includes, for example, tracking of whether the datacenter entities in a datacenter are up or down (e.g., running, not running, or being built). In various embodiments, execution dependency module 120 access datacenter entities state information 552 from datacenter entities state database 550.

As described above, in various embodiments, a request to orchestration engine 110 specifies whether the request is a build or destroy request for a particular datacenter. In response to the request, execution dependency module 120 may check against datacenter entities state database 550 to determine whether the particular datacenter already has datacenter entities (e.g., services). If the particular datacenter already has datacenter entities, then the request is an update request (e.g., update request 512) for the particular datacenter. Otherwise the request may be handled as a new orchestration request (e.g., request 112), described in FIGS. 1 and 2 above. The illustrated embodiment of FIG. 5 depicts various components capable of handling update request 512.

In various embodiments, orchestration engine 110 receives update request 512 from a user or client of system 100. As described above, request 512 may be determined to be a request to update an existing datacenter on a cloud platform associated with system 100 by either building or destroying one or more datacenter entities (such as one or more services) on the existing datacenter. Accordingly, in some embodiments, request 512 is a request to orchestrate the addition of one or more datacenter entities to the existing datacenter. While in other embodiments, request 512 is a request to orchestrate the removal (e.g., destruction) of one or more existing datacenter entities on the existing datacenter or the entire datacenter. In some embodiments, request 512 is received through a gateway (e.g., an orchestration gateway). The gateway may include authentication or authorization components to ensure the validity of request 512 and that only authenticated or authorized user/clients can trigger the update to the datacenter. In one contemplated embodiment, request 512 is received through an application programming interface (API) associated with system 100 or the gateway to the system. In another contemplated embodiments, request 512 is received through a server interface with system 100. Request 512 may also include information such as, but not limited to, datacenter entity names, datacenter names, datacenter entity groups, a release version of the declarative specification, and an indicator of the datacenter target for the update.

As shown in FIG. 5, request 512 is received by execution dependency module 120 in orchestration engine 110. In certain embodiments, execution dependency module 120 accesses datacenter entities state information 552 from datacenter entities state database 550 in response to receiving request 512. Execution dependency module 120 may access datacenter entities state information 552 to determine the state of datacenter entities that already exist in the datacenter targeted by request 512. The state of the datacenter entities that already exist in the target datacenter may then be used to determine datacenter entities involved with the update. For example, execution dependency module 120 may compare a list of the datacenter entities in request 512 (such as those specified in a declarative specification of the request) with a list of the datacenter entities already in the target datacenter. The comparison may determine which datacenter entities need to be built or destroyed to complete the update of the datacenter according to request 512. The datacenter entities that are compared may include the particular datacenter entities in request 512 as well as start dependencies for the particular datacenter entities (e.g., the datacenter entities on which the particular datacenter entities depend for starting or running, as described herein).

In various embodiments, execution dependency module 120 determines execution dependencies associated with the datacenter entities involved with the update. In some embodiments, the declarative specification for the target datacenter of request 512 may be utilized to determine execution dependencies for the datacenter entities in the update. For example, the declarative specification in request 512 may be utilized by execution dependency module 120 to determine execution dependencies for the datacenter entities (including start dependencies) that are being added or destroyed as part of the update. As described herein, execution dependencies need to be completed before datacenter entities reliant on the execution dependencies can be orchestrated. When the execution dependencies are completed, the datacenter entities reliant on the execution dependencies are considered to be ready for orchestration and an orchestration workflow involving these datacenter entities can begin.

In certain embodiments, execution dependency module 120 interfaces with execution dependencies for the update 540 to initiate these execution dependencies and determine completion indications for these execution dependencies. For example, execution dependency module 120 may provide execution initiation requests 522 to the execution dependencies for the datacenter entities involved in the update and assess activity completion indications 524 for the execution dependencies initiated. In certain embodiments, as described herein, execution initiation requests 522 include requests to only the execution dependencies that are involved with updating the datacenter entities on the datacenter (e.g., execution dependencies only for the update). For instance, execution dependencies 540 is a subset of the total execution dependencies needed for an entirely new build of a datacenter. Thus, any execution dependencies, which are not involved in the creation of a new datacenter or the destruction of the entire datacenter, are not part of the subset in execution dependencies 540. Execution dependency initiation requests 522 to execution dependencies 540 may be signals or other indicators that inform the execution dependencies to begin activities to get the execution dependencies up and running. In some embodiments, execution dependency initiation requests 522 may include other functions (such as SLA callback 652, described herein). Execution dependency completion indications 524 may include indications informing execution dependency module 120 that the execution dependencies 540 are completed. Thus, execution dependency module 120 may be capable of both initiating execution dependencies 540 and determining when the execution dependencies are completed.

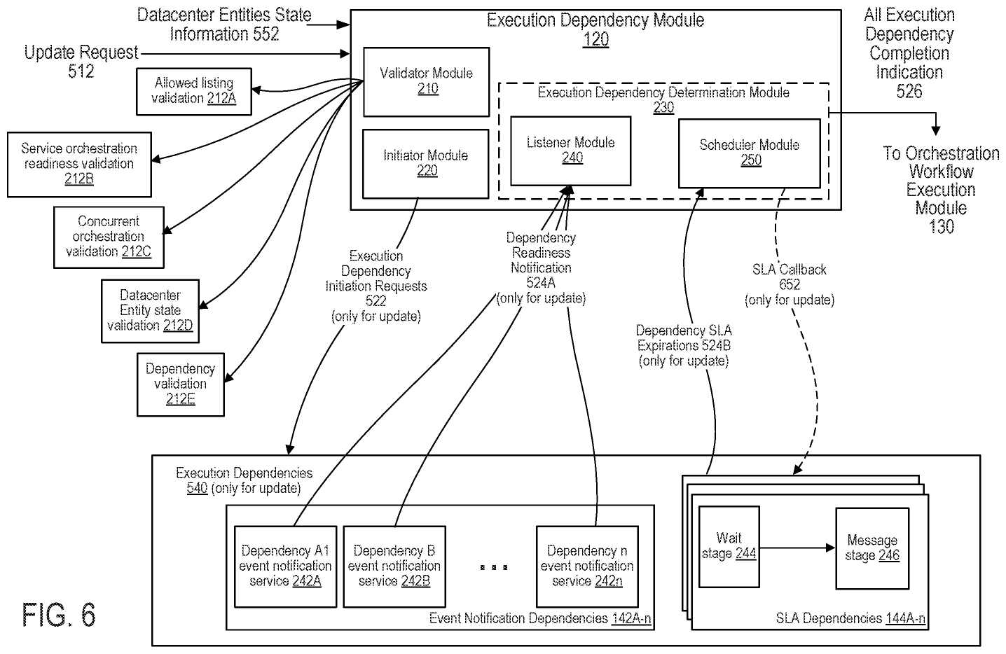

FIG. 6 is a block diagram illustrating example elements of execution dependency module 120 for an incremental update to an existing datacenter on a cloud platform, according to some embodiments. In the illustrated embodiment, execution dependency module 120 includes validation module 210, initiator module 220, and execution dependency determination module 230, as previously described. In various embodiments, validator module 210 may perform the various validations of aspects related to orchestration in response to receiving update request 512. As described above, possible validations include, but are not limited to, allowed (service) listing validation 212A, service orchestration readiness validation 212B, and concurrent orchestration validation 212C.

In certain embodiments, validations additionally include datacenter entity state validation 212D and dependency validation 212E. Datacenter entity state validation 212D may be a validation of the state of the various datacenter entities involved with the update to the datacenter. Dependency validation 212E may be a validation of dependencies involved with the update to the datacenter. For instance, dependency validation 212E may be a validation of start dependencies and particular datacenter entities that depend on the start dependencies. Datacenter entity state validation 212D and dependency validation 212E provide additional capabilities for responding to update request 512.

For instance, datacenter entity state validation 212D may include validation of the states of datacenter entities involved with update request 512 in order to determine whether the datacenter entities are already up or down in the existing datacenter. For instance, when update request 512 includes a request to add a datacenter entity, datacenter entity state validation 212D may validate the states of datacenter entities to determine whether the datacenter entity already exists in the datacenter and is up and running. To the contrary, when update request 512 includes a request to destroy a datacenter entity, datacenter entity state validation 212D may validate the states of datacenter entities to determine whether the datacenter entity is already down in the datacenter. Accordingly, datacenter entity state validation 212D may be enabled to avoid instances of adding a datacenter entity to the existing datacenter that already exists or destroying a datacenter entity that is already down on the existing datacenter. In some embodiments, when datacenter entity state validation 212D determines that a datacenter entity requested to be added already exists or a datacenter entity requested to be destroyed is already down, validation module 210 may provide an indication of the determination to the entity making request 512 (e.g., the user or other system). In various embodiments, dependency validation 212E includes validation of the states of start dependencies for the datacenter entities associated with update request 512. For instance, dependency validation 212E may validate that the various start dependencies for a datacenter entity are in the correct state for being built or destroyed depending on whether a build or destroy of the datacenter entity is being orchestrated according to request 512.

As shown in FIG. 6, initiator module 220 provides execution dependency initiation requests 522 to execution dependencies 540. In certain embodiments, as described above, execution dependency initiation requests 522 includes initiation requests for a subset of the total execution dependencies associated with the target datacenter. For example, execution dependency initiation requests 522 may only include initiation requests for the subset of execution dependencies in execution dependencies 540. In some embodiments, execution dependencies that are already known to have been completed (e.g., as determined by assessment of datacenter entities state information 552) may also not be part of execution dependency initiation requests 522 since there is no reason to duplicate their initiation for the datacenter. After execution dependency initiation requests 522 are provided to execution dependencies for the update 540 by initiator module 220, execution dependency determination module 230 may determine when execution dependencies are completed. In various embodiments, execution dependency determination module 230 includes listener module 240 and scheduler module 250. Listener module 240 and scheduler module 250, as described above, may implement different mechanisms for determining whether execution dependencies 540 have been completed.

As described herein, some execution dependencies may be event notification dependencies 142. For event notification dependencies 142, listener module 240 may wait and “listen” for dependency readiness notifications 524A to be received from each of dependency event notification services 242A-n, where n is the total number of event notification dependencies 142A-n. Dependency readiness notifications 524A are a subset of execution dependency completion indications 524, shown in FIG. 5, associated with event notification dependencies 142. In various embodiments, for the incremental update, listener module 240 only waits for execution dependencies that have been initiated by execution dependency initiation requests 522. Any execution dependencies that are not a part of the update (such as those that are not part of execution dependencies 540) or have already been determined to be completed (e.g., according to assessment of datacenter entity status checks using datacenter entities state information 552) are not waited on as these execution dependencies do not require being checked on. In some embodiments, such execution dependencies may be set a status of “NOT_APPLICABLE” or something similar indicating their status does not need to be checked. For execution dependencies being checked, when a dependency readiness notification 524A that an execution dependency has completed is received, listener module 240 may set a status of the execution dependency as “NOTIFIED” OR “READY” for all the datacenter entities that depend on the execution dependency.

In various embodiments, scheduler module 250 is implemented to handle execution dependencies that are subject to a service level agreement (SLA)—SLA dependencies 144, which are described above. When a predetermined time period for an SLA dependency 144 expires, scheduler module 250 determines dependency SLA expirations 524B for the SLA dependency, which indicates that the dependency may be considered to be completed. Dependency SLA expirations 524B are a subset of execution dependency completion indications 524, shown in FIG. 5, associated with SLA dependencies 144. It should be noted that, in some embodiments, no SLA initiation requests may be sent to SLA dependencies 144 as part of execution dependency initiation requests 522. For instance, as discussed above, no execution dependency initiation requests 522 may be sent to execution dependencies that are not a part of the update or have already been determined to be completed and have a status set to “NOT_APPLICABLE”. Accordingly, such execution dependencies will not be sent any SLA initiation requests as well. In some embodiments, SLA callback 652 is included as part of execution dependency initiation requests 522. SLA callback 652 may be similar to SLA callback 252, described above, and implement a task timer function that is assessed by scheduler module 250 to determine when dependency SLA expirations 524B are issued.

As with the previously described end-to-end orchestration, once all the execution dependencies for a particular datacenter entity (e.g., particular service) involved with the update have a status of “READY” (e.g., “NOTIFIED” or “SLA” via either event notification dependencies 142 or SLA dependencies 144), execution dependency determination module 230 may set the status of the particular datacenter entity to “READY TO ORCHESTRATE” or a similar state status. Having the status of the datacenter entities associated with the update request being automatically updated based on completion of execution dependencies for the datacenter entities according to event notifications or expiration of SLAs eliminates the need for manual checking of the execution dependencies (e.g., manual callouts to the execution dependencies). At this point, all the execution dependencies for the update are completed, which means that the orchestration workflow for the update can be executed. Accordingly, an orchestration to update the datacenter entities on the datacenter is ready to begin and execution dependency determination module 230 in execution dependency module 120 provides “all execution dependency completion indication 526” to orchestration workflow execution module 130, as shown in FIG. 5.

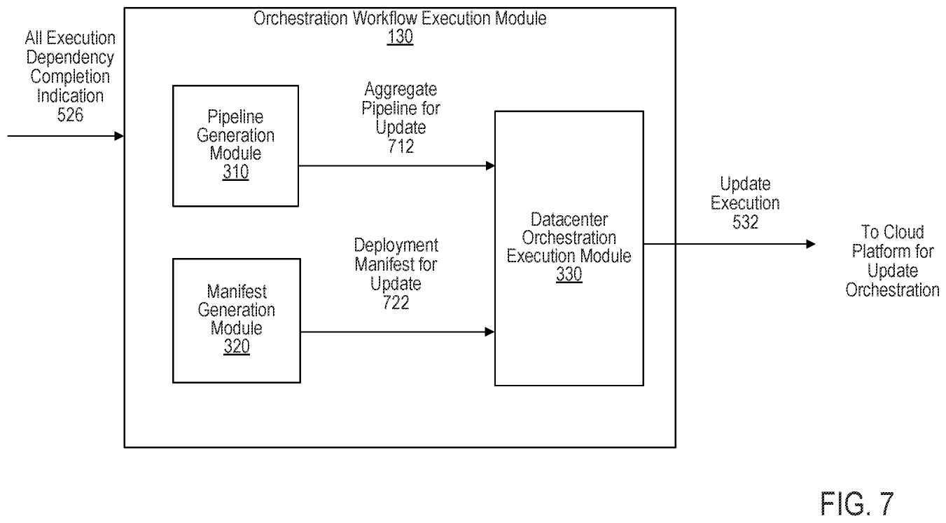

FIG. 7 is a block diagram illustrating example elements of orchestration workflow execution module 130 for an incremental update to an existing datacenter on a cloud platform, according to some embodiments. In the illustrated embodiment, orchestration workflow execution module 130 includes pipeline generation module 310, manifest generation module 320, and datacenter orchestration execution module 330, which have been described previously. In various embodiments for an incremental update to an existing datacenter, pipeline generation module 310 generates aggregate pipeline 712 for updating the datacenter entities for the target datacenter. Execution of aggregate pipeline 712 may be implemented to update the datacenter entities for the datacenter on the cloud platform (e.g., either add datacenter entities to the datacenter or destroy datacenter entities from the datacenter. Generating aggregate pipeline 712 may include collecting relevant metadata for the pipelines in the aggregate pipeline. The metadata may include, but not be limited to, layout information, dependency information, service attributes, or other information available from the declarative specification or agreements (e.g., SLAs) for the datacenter entities being added or destroyed. Pipeline stages may then be setup based on the metadata and a final specification for aggregate pipeline 712 to update the datacenter entities on the datacenter may be developed. Pipeline generation module 310 may output the specification of aggregate pipeline 712 to datacenter orchestration execution module 330, as shown in FIG. 7.

In some embodiments, manifest generation module 320 generates and outputs deployment manifest 722. Deployment manifest 722 may be an artifact version map, a software artifact version map, or a software release map associated with updating the datacenter entities on the target datacenter. In certain embodiments, deployment manifest 722 includes a description associating the datacenter entities to be updated on the datacenter with versions of software artifacts (e.g., software releases) targeted for the datacenter entities.

In various embodiments, aggregate pipeline 712 and deployment manifest 722 may be implemented by datacenter orchestration execution module 330 to provide instructions for update execution 532. In some embodiments, update execution 532 includes cloud platform specific pipelines for the target datacenter. Update execution 532 may be provided to the cloud platform of the target datacenter to update (e.g., build or destroy) the datacenter entities for the datacenter. In certain embodiments, update execution 532 includes instructions for execution of aggregate pipeline 712 in conjunction with deployment manifest 722. As aggregate pipeline 712 is based on a declarative specification of the target datacenter, the datacenter entities are updated on the cloud platform according to the declarative specification. In some embodiments, as described above, a declarative specification and/or aggregate pipeline for the target datacenter may be updated in view of update execution 532 being provided to the cloud platform. For example, in datacenter entity addition embodiments, the datacenter entities being added to the datacenter (along with any dependencies) may be added to the declarative specification and/or aggregate pipeline 712 while, in service destroy embodiments, the datacenter entities being destroyed on the datacenter (along with any dependencies) may be removed from the declarative specification and/or aggregate pipeline.

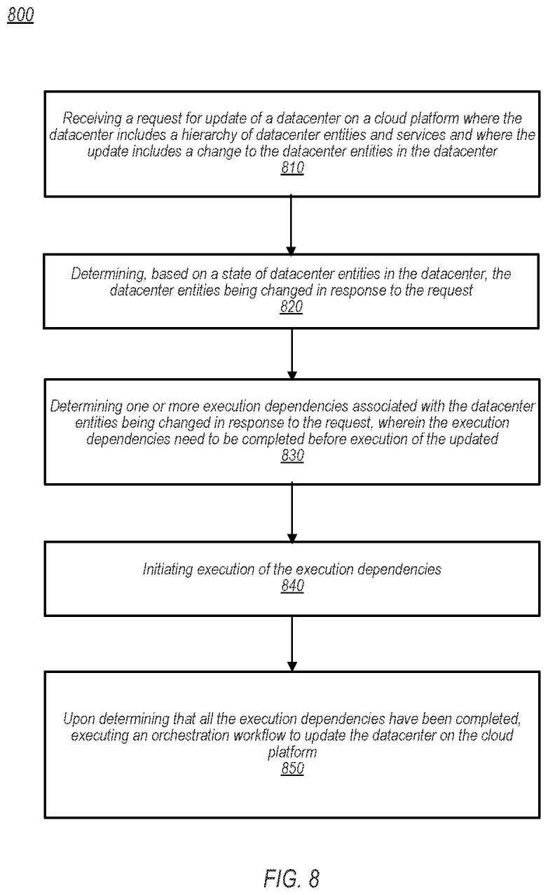

FIG. 8 is a flow diagram of an embodiment of a method for executing incremental orchestration for a datacenter on a cloud platform. In various embodiments, method 800 may be performed by system 100, as shown in FIGS. 5-7. In some embodiments, system 100 may include (or have access to) a non-transitory, computer-readable medium having program instructions stored thereon that are executable by the system to cause the operations described with reference to FIG. 8.

At block 810, method 800 begins by receiving, at a computer system, a request for update of a datacenter on a cloud platform where the datacenter includes a hierarchy of datacenter entities and services and the update includes a change to the datacenter entities in the datacenter.

Method 800 continues at block 820 by determining, based on a state of datacenter entities in the datacenter, the datacenter entities being changed in response to the request.

At block 830, method 800 proceeds by determining one or more execution dependencies associated with the datacenter entities being changed in response to the request where the execution dependencies need to be completed before execution of the update.

At block 840, method 800 proceeds by initiating execution of the execution dependencies.

At block 850, method 800 proceeds by, upon determining that all the execution dependencies have been completed, executing an orchestration workflow to update the datacenter on the cloud platform.

### Automated Retries

Described above are various techniques for end-to-end orchestration of a datacenter on a cloud platform along with techniques for updating existing datacenters on cloud platforms. As described herein, an orchestration may include the execution of pipelines associated with datacenter entities for a datacenter on a cloud platform. During the execution of the pipelines, potential failures may occur in the execution due to failure in execution of datacenter entity pipelines (such as build/destroy pipelines). In many instances, failures in datacenter entity pipelines are caused by intermittent issues are that are short term or temporary in nature. For example, intermittent issues such as, but not be limited to, network errors, unstable pipelines, or timing issues may cause temporary failures in datacenter entities. With the intermittent issues being temporary, in many instances, failure in pipeline execution may be resolved by simply restarting the pipeline execution once the issues are resolved (such as a network being reestablished).

Current solutions to overcoming intermittent issues often involve manually intervention in attempting to fix the issues along with restarting the entire process of orchestrated execution (e.g., builds/destroys) of the datacenter or a significant portion of the orchestrated execution. For example, when even a single failure occurs at some location in an aggregate pipeline, the entire aggregate pipeline may fail in its execution. Expert operators may then manually attempt to determine the cause of the issue and resolve it followed by restarting of the aggregate pipeline from its beginning. Restarting the aggregate pipeline from the beginning may involve unnecessary rerunning of datacenter entity pipelines or other datacenter entities that successfully ran during the failed attempt since the failure may have occurred elsewhere in the aggregate pipeline. This manual intervention and restart process decreases reliability, scale, and speed associated with execution of an orchestration.

Further, because of the high volume of intermittent errors that can occur during execution of pipelines and because an aggregate pipeline may fail when even a single datacenter entity fails, the number of manual restarts of the orchestration execution can be cumbersome. Additionally, the time required for intervention steps such as bug reporting, investigation, bug fix, fix rollout, and rerunning of the entire pipeline may cause delays over periods of days for simple, intermittent issues that may have been simply solved by a rerun without any of the additional intervention steps. The manual intervention process is tedious and time-intensive while also including manual coordination, sequencing, and monitoring often between several users to resolve what are merely intermittent issues. The manual intervention process may also be vulnerable to errors arising from manual steps such as sequencing or determining where the pipeline needs to be rerun. Delays may also occur due to the lack of parallelization and coordination between teams.

Previous solutions have been proposed to overcome some of the problems associated with handling of intermittent issues that cause failures of pipeline execution. One example is found in U.S. Pat. No. 11,356,508 to Vergara and Pattan (“the '508 patent”), which is incorporated by reference as if fully set forth herein. The '508 patent describes various techniques for adding retry strategies to aggregate pipelines where the retry strategies were invoked when a failure in any stage of an aggregate pipeline causes failure of the aggregate pipeline. The retry strategies implemented in the '508 patent are, however, placed at the higher aggregate pipeline level instead of individual datacenter entity pipeline levels, which limits the capabilities of the retry strategies and creates a need for manual intervention. Thus, the retry strategies implemented in the '508 patent and still require at least some manual intervention.

The present disclosure describes a solution that overcomes many of the issues of previous solutions by placing retry stages in individual datacenter entity pipelines and fully automating execution of retries within the datacenter entity pipeline. In certain embodiments, the retry stages are placed as the last (e.g., final) stages of individual datacenter entity pipelines. In various embodiments, failures and successes of prior stages in the individual datacenter entity pipelines are tracked to allow retries to be started from the earliest (e.g., first) stage that failed in an individual datacenter entity pipeline when failure of the pipeline is detected. For instance, stages that have already been run successfully are not rerun to allow only failed stages and stages not yet run to be run during retries. In some embodiments, a stage in the pipeline after a failed stage is skipped in the retry process until the earlier failed stage before it successfully executes its retry. This avoids rerunning stages that may have failed (or not run initially) due to the failure of the earlier stage. It should be noted that while the placement of retry stages in datacenter entity pipelines is discussed in combination with end-to-end and increment orchestration within the present disclosure, the implementation of retry stages in datacenter entity pipelines described herein may be applied to any orchestration that includes datacenter entity pipelines with stages. For instance, the implementation of retry stages described herein may be applied to the orchestration described in U.S. Patent No. 2023/0244463A1.

Placing retry stages in individual datacenter entity pipelines allows each datacenter entity pipeline to have its own retry stage and retry strategy that is automatically invoked by the datacenter entity pipeline agnostically of other datacenter entity pipelines in the aggregate pipeline. Accordingly, the various individual datacenter entity pipelines have retry strategies that are operated in parallel (e.g., independently) and invocation of the retry strategy is not dependent on other pipelines (e.g., higher pipelines such as the aggregate pipeline or other datacenter entity pipelines). Additionally, when one datacenter entity pipeline invokes its retry strategy after a failure, other datacenter entity pipelines that do not depend on the failed datacenter entity pipeline may continue execution due to the agnostic and independent setup of the retry stages. Yet further, placing a retry stage in an individual datacenter entity pipeline allows the retry strategy to be fully automated and for the retry strategy to be defined by the owner of the individual datacenter entity pipeline (e.g., by the datacenter entity owner's manifest) where the retry strategy is specific to that pipeline without any reporting to other pipelines.

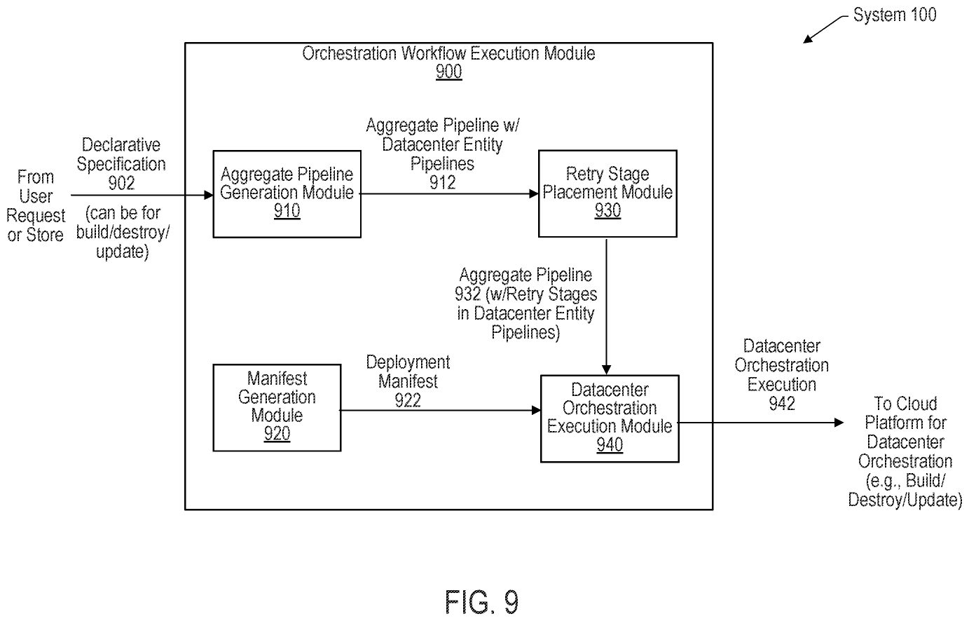

FIG. 9 is a block diagram illustrating example elements of a system implementing retries during execution of an orchestration workflow for a datacenter on a cloud platform, according to some embodiments. In the illustrated embodiment, orchestration workflow execution module 900 includes aggregate pipeline generation module 910, manifest generation module 920, retry stage placement module 930, and datacenter orchestration execution module 940. Orchestration workflow execution module 900 may be a component in system 100. For example, orchestration workflow execution module 900 may be a component in an orchestration engine of system 100 (such as orchestration engine 110, shown in FIG. 1 or orchestration engine 510, shown in FIG. 5).

In certain embodiments, aggregate pipeline generation module 910 accesses declarative specification 902 in order to conduct an orchestration for a datacenter on a cloud platform. In some embodiments, declarative specification 902 may be received as part of a user request (e.g., an orchestration request) to build, destroy, or update a datacenter on a cloud platform.

In various embodiments, aggregate pipeline generation module 910 generates aggregate pipeline 912 for a datacenter. As described herein, aggregate pipeline 912 is a pipeline that includes a hierarchy of smaller pipelines (such as datacenter entity pipelines, datacenter entity group pipelines, cell pipelines, or combinations thereof). Datacenter entity group pipelines and cell pipelines may be pipelines that include one or more datacenter entity pipelines. In certain embodiments, a datacenter entity pipeline is a pipeline that include stages with the stages representing actions (e.g., instructions) for provisioning and deployment of a datacenter entity associated with the pipeline intended for a specific environment. Accordingly, execution of an aggregate pipeline may execute the hierarchy of smaller pipelines build, destroy, or update datacenter entities (e.g., services) for a datacenter on a cloud platform.

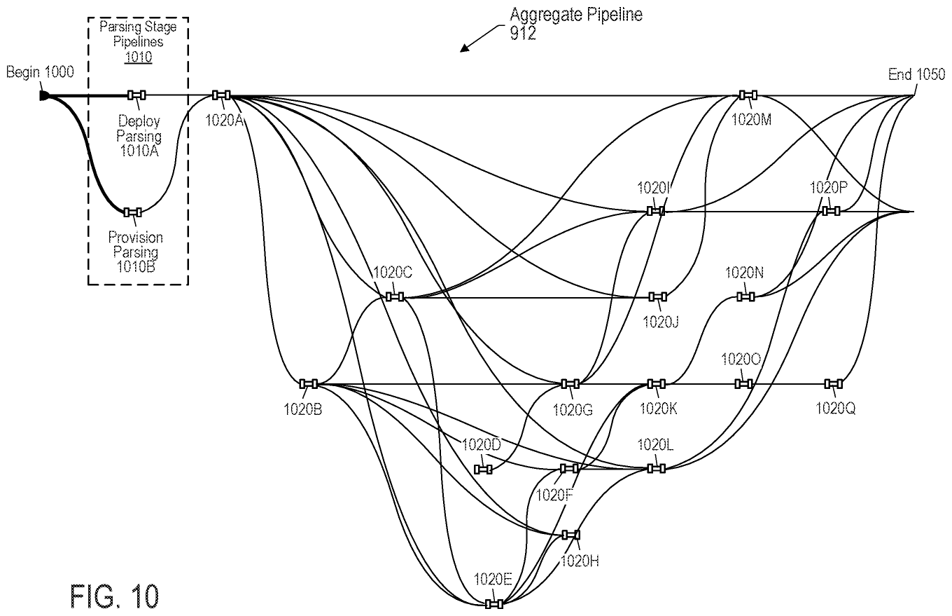

FIG. 10 is a block diagram illustration of an example aggregate pipeline 912, according to some embodiments. In the illustrated embodiment, aggregate pipeline 912 includes parsing stage pipelines 1010 and datacenter entity pipelines 1020 between pipeline begin 1000 and pipeline end 1050. Pipeline begin 1000 and pipeline end 1050 may represent connections to other datacenter entity pipelines or aggregate pipelines. In various embodiments, parsing stage pipelines 1010 include deploy parsing pipeline 1010A and provision parsing pipeline 1010. Deploy parsing pipeline 1010A and provision parsing pipeline 1010B may be implemented to extract dynamic configuration data from the deployment manifest used to control behavior of aggregate pipeline 912.

In certain embodiments, datacenter entity pipelines 1020 are individual logical entities associated with individual datacenter entities for a datacenter orchestration. For example, in the illustrated embodiment, there are 17 (seventeen) datacenter entities and each individual datacenter entity is associated with one of the depicted datacenter entity pipelines 1020A-1020Q. As shown, each individual datacenter entity gets its own datacenter entity pipeline 1020 within aggregate pipeline 912 instead of some datacenter entities being combined into multiple stages in the aggregate pipeline. Providing each individual datacenter entity with its own pipeline allows the addition of retry stages to each individual datacenter entity, as described below, instead of a retry stage operating multiple datacenter entities. Thus, as shown in the example of FIG. 10, aggregate pipeline 912 is an aggregation of datacenter entity pipelines 1020A-Q for the individual datacenter entities.

In various embodiments, generating datacenter entity pipelines 1020 includes collecting relevant metadata for orchestrating the pipelines. For example, metadata for the various datacenter entities associated with the datacenter entity pipelines may be collected. The metadata may include, but not be limited to, layout information, dependency information, datacenter entity attributes, or other information available from the declarative specification or agreements (e.g., SLAs) with the datacenter entities. Stages in the datacenter entity pipelines may then be setup based on the metadata and a final specification of the aggregate pipeline may be developed. As shown by the illustration of FIG. 10, aggregate pipeline 912 includes the final specification of the aggregate pipeline including all the datacenter entity pipelines 1020 along with any parsing stage pipelines 1010.

Turning back to FIG. 9, as shown, aggregate pipeline 912 is provided to retry stage placement module 930. In certain embodiments, retry stage placement module 930 adds retry stages to individual datacenter entity pipelines (e.g., datacenter entity pipelines 1020) in aggregate pipeline 912 to generate aggregate pipeline 932. Accordingly, aggregate pipeline 932 includes aggregate pipeline 912 with retry stages added to the individual datacenter entity pipelines.

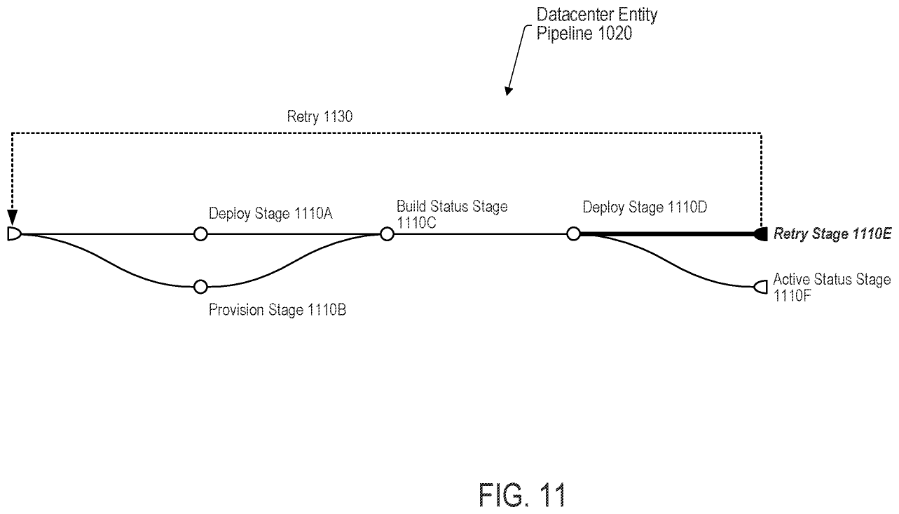

FIG. 11 is a block diagram illustration of an example datacenter entity pipeline 1020 with a retry stage, according to some embodiments. In the illustrated embodiment, datacenter entity pipeline 1020 includes a plurality of stages 1110A-F. Datacenter entity pipelines may have from zero to any number of deploy stages and from zero to any number of provision stages (but the pipeline must contain at least one provision or deploy stage). In some embodiments, datacenter entity pipeline 1020 includes at least one deploy stage (e.g., deploy stage 1110A) and at least one provision stage (e.g., provision stage 1110B). Other examples of stages that may be included in datacenter entity pipeline 1020 include, but are not limited to, build status stage 1110C and active status stage 1110F. A build status stage may include instructions to set a bootstrap status of a datacenter entity pipeline to “build” indicating the datacenter entity pipeline is in the build phase. An active status stage may include instructions to set the bootstrap status of a datacenter entity pipeline to “active” indicating the datacenter entity pipeline is up and running. Various other stages representing instructions for provisioning and deployment of a datacenter entity associated with the datacenter entity pipeline may also be contemplated. Accordingly, datacenter entity pipeline 1020 is merely one example of many different variations of a datacenter entity pipeline that are possible inclusion in an aggregate pipeline for orchestrating a datacenter.

In certain embodiments, as shown in FIG. 11, datacenter entity pipeline 1020 includes retry stage 1110E. Retry stage 1110E may be placed as a last stage (e.g., after all deploy/provision stages) along with active status stage 1110F. Retry stage 1110E may be placed in datacenter entity pipeline 1020 by retry stage placement module 930, shown in FIG. 9. In certain embodiments, similar retry stages are placed as last stages in each individual datacenter entity pipeline of an aggregate pipeline. For example, each individual datacenter entity pipeline 1020A-Q in aggregate pipeline 912, shown in FIG. 10, may include a retry stage as a last stage.

Retry stage 1110E may, in some embodiments, be referred to as an “Invoke Retrier” stage. In various embodiments, retry stage 1110E includes one or more conditional expressions. The conditional expressions may operate on parameters that are assessed in the datacenter entity pipeline to determine when datacenter entity pipeline 1020 is rerun, how the datacenter entity pipeline is rerun, or if the datacenter entity pipeline is rerun. Examples of parameters that may be assessed include, but are not limited to, retry enablement, retry strategy, and failure determination (e.g., determination of failures in prior stages of datacenter entity pipeline). These parameters and their associated conditional expressions may be implemented as part of adding retry stage 1110E to datacenter entity pipeline 1020.

In various embodiments, retry enablement includes allowing retries to be enabled/disabled by a user or a system executing the pipeline. For example, retries may be enabled/disabled by adding a selectable parameter that allows a user interfacing with the system to select enablement or disablement of retries during execution of an orchestration workflow. Thus, in some instances, retries may be disabled and the retry stages do not operate during execution of the pipeline. The selection of enablement/disablement of retries may be done on a datacenter entity pipeline level or on an overall level (e.g., an aggregate pipeline level or a full orchestration workflow level).

In certain embodiments, a retry strategy (e.g., the retry strategy to be invoked in event of pipeline execution failure) is defined by a datacenter entity owner of the datacenter entity associated with datacenter entity pipeline 1020. For instance, the retry strategy may be defined according to an SLA of the datacenter entity. One example of a retry strategy that may be implemented is a fixed backoff retry strategy. In a fixed backoff retry strategy, the datacenter entity pipeline may execute a retry attempt after a fixed time interval as well as a maximum number of retry attempts (both of which may be defined as parameters in the SLA). In other embodiments, the retry strategy may be another retry strategy, such as a custom retry strategy defined by the datacenter entity owner. In embodiments where a maximum number of retry attempts is defined, a parameter may be added on the datacenter entity pipeline level to track the number of retry attempts. Accordingly, when the maximum number of retry attempts is reached according to the retry attempt tracker, a timeout/fail point is reached and the datacenter entity pipeline is marked as failed. A parameter may also specify the fixed time interval to wait for executing a retry attempt.

In various embodiments, failure determination is a parameter that is assessed at retry stage 1110E to determine whether a prior stage has failed its execution during pipeline execution. For example, a determination may be made whether a prior stage such as a deploy stage or a provision stage failed during pipeline execution. These parameters, along with any other parameters defined for datacenter entity pipeline 1020, may be evaluated as part of the conditional expressions to determine whether to invoke a retry of the datacenter entity pipeline.

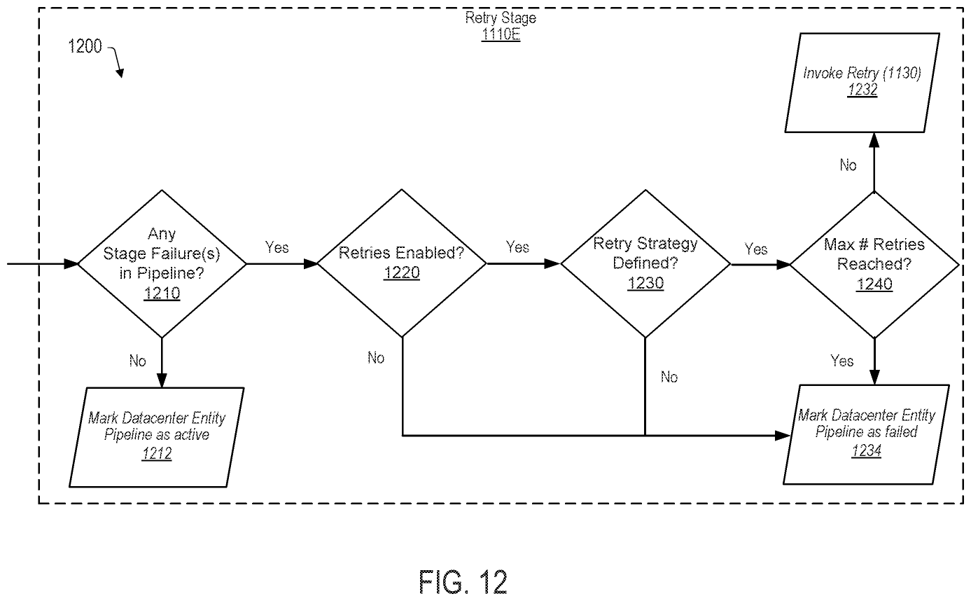

FIG. 12 is a flow diagram illustrating an example retry determination process for a retry stage in a datacenter entity pipeline, according to some embodiments. In illustrated embodiment, process 1200 is implemented in retry stage 1110E to determine whether a retry attempt for datacenter entity pipeline 1020 is made. Process 1200 includes evaluations of parameters according to conditional expressions at a retry stage in a datacenter entity pipeline. In various embodiments, process 1200 begins with determining whether there are failures in any stages of the datacenter entity pipeline at 1210. If no stage has failed (“No”), then process 1200 ends with marking the datacenter entity pipeline as active (e.g., successful) at 1212.

If a stage has failed (“Yes”), then process 1200 continues at 1220 with determining whether retries are enabled (e.g., whether the enable/disabled parameter is set to enabled). If “No” at 1220, then process 1200 ends and the datacenter entity pipeline is marked as failed at 1234 since there will not be a retry of the datacenter entity pipeline. If “Yes” at 1220, then process 1200 continues at 1230 with assessing whether a retry strategy is defined (e.g., by the datacenter entity owner). If “No” at 1230, then process 1200 ends and the datacenter entity pipeline is marked as failed at 1234 since there is no retry strategy and no assumptions are to be made for the retry strategy. If “Yes” at 1230, then process 1200 continues at 1240 with determining whether a maximum number of retries defined by the retry strategy has been reached. The number of datacenter entity pipeline retries that have been attempted may be tracked by a parameter installed in the datacenter entity pipeline. If “Yes” at 1240, then the maximum number of retries has been reached and process 1200 ends and the datacenter entity pipeline is marked as failed at 1234. If “No” at 1240, then a retry is invoked at 1232.

In various embodiments, invoking the retry includes restarting datacenter entity pipeline 1020, as shown by “Retry 1130” in FIG. 11. While the retry is invoked at the beginning of datacenter entity pipeline 1020, conditional expressions may be added to individual stages to ensure that stages that are already successful in any previous run of the datacenter entity pipeline are not rerun during a retry. Including conditional expressions for ensuring stages that are already successful are not rerun implements a retry strategy where retries are invoked only at stages that have failed. Additionally, conditional expressions may be added to individual stages to prevent rerunning a stage if a stage prior to a particular stage has failed. Preventing rerun of a later stage when an earlier stage has failed may be desired to be avoided since the later stage may not run successfully until the earlier stage has run successfully. Including these conditional expressions (e.g., the conditional expressions for ensuring stages that are already successful are not rerun and to preventing rerunning of a stage if a stage prior to a particular stage has failed) implements a retry strategy where retries are first invoked at the earliest failed stage in the datacenter entity pipeline.

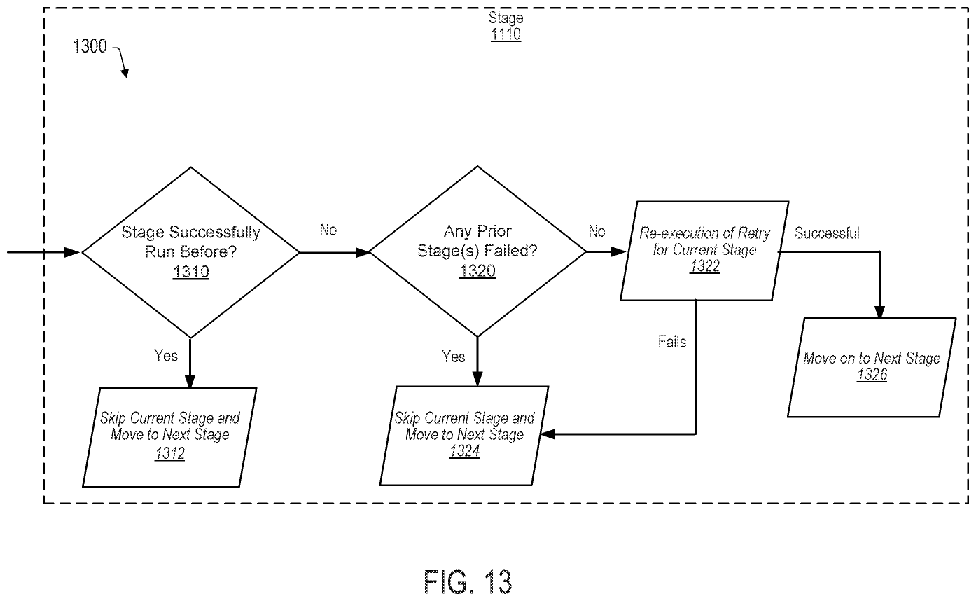

FIG. 13 is a flow diagram illustrating an example conditional expression evaluation process for individual stages in a datacenter entity pipeline, according to some embodiments. In illustrated embodiment, process 1300 may be invoked at individual stages in a datacenter entity pipeline (e.g., stages 1110A-1110D, shown in FIG. 11) during any run of the datacenter entity pipeline (including the first initial run). Note that during the initial run, each stage will attempt to run since no stage has been marked as successfully run based on process 1300. Process 1300 begins at 1310 with assessing whether the stage has been successfully run before (e.g., in a prior execution of the datacenter entity pipeline). It should be noted that the success or failure of stage executions may be tracked by a parameter installed in the datacenter entity pipeline. For instance, the parameter may list “successful stages” in the datacenter entity pipeline corresponding to stages with successful executions where any stage not listed in the parameter is considered to have failed its execution.

If the assessment is “Yes” at 1310, then the retry attempt for the current stage is skipped and the process is moved to the next stage in the datacenter entity pipeline at 1312. If the assessment is “No” at 1310, then process 1300 may continue at 1320 with assessing whether any prior stages before the current stage (e.g., an “earlier stage” in the pipeline) has failed. If “No” is assessed at 1320, then no earlier stages have failed and re-execution of the retry for the current stage is implemented at 1322. At 1322, the current stage is re-executed and is either “Successful” or “Fails”, as shown in FIG. 13. If the re-execution of the current stage is successful then process 1300 moves on to the next stage at 1326. If the re-execution fails at 1322, then process 1300 skips the current stage and moves to the next stage at 1324. Process 1324 also moves to 1324 when, at 1320, it is determined that a prior stage to the current stage has failed. Note that at 1324, since at least one stage in the datacenter entity pipeline is marked as failed, all subsequent stages will be skipped when evaluating process 1300. Thus, eventually the retry process moves back to the retry stage (e.g., retry stage 1110E) where further evaluation of the retry process (e.g., process 1200) is made before attempting further retries of the datacenter entity pipeline.

In certain embodiments, retry stages placed in datacenter entity pipelines (e.g., retry stage 1110E) include expressions or statements that indicate the retry is attempted automatically based on the conditional expressions. For example, any statement in a file associated with a retry strategy that includes a manual step for attempting the retry (such as prompting a user to approve a retry) may be overwritten such that the manual step is skipped and the retry attempt begins automatically without manual intervention. As a specific example, a statement such as “ask_before_retry” may be part of language defining a retry strategy. To automate execution of the retry, the “ask_before_retry” statement may be set to “false” so that there is no ask or prompt for manual input. Removing any manual steps for initiation retries allows for full automation of retries within an orchestration workflow. Fully automating retries within the orchestration workflow accordingly allows the orchestration workflow to be a fully automatic process with retry capability for resolving intermittent issues, as described herein.

Turning back to FIG. 9, retry stage placement module 930 has now added retry stages to individual datacenter entity pipelines in aggregate pipeline 912 to generate aggregate pipeline 932. Aggregate pipeline 932 may be provided to datacenter orchestration module 940. Datacenter orchestration execution module 940 may implement aggregate pipeline 932 in combination with deployment manifest 922 from manifest generation module 920 to generate instructions for datacenter orchestration execution 942 (e.g., instructions for the orchestration workflow). In certain embodiments, datacenter orchestration execution 942 includes instructions for execution of aggregate pipeline 932 in conjunction with deployment manifest 922. In some embodiments, datacenter orchestration execution 942 includes a detailed pipeline that is specified for the target cloud platform, as described herein. Datacenter orchestration execution 942 may then be provided to the target cloud platform for execution of the datacenter orchestration on the cloud platform. As aggregate pipeline 932 is based on the declarative specification 902, the datacenter is orchestrated on the cloud platform according to the declarative specification with cloud platform specifics defined by deployment manifest 922.

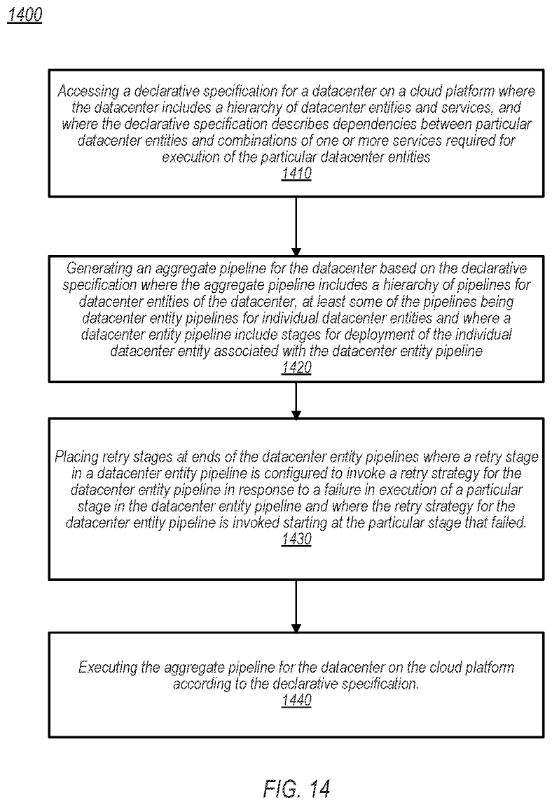

FIG. 14 is a flow diagram of an embodiment of a method for implementing retry stages in an aggregate pipeline. In various embodiments, method 1400 may be performed by system 100, as shown in FIG. 9. In some embodiments, system 100 may include (or have access to) a non-transitory, computer-readable medium having program instructions stored thereon that are executable by the system to cause the operations described with reference to FIG. 14.

At block 1410, method 1400 begins by accessing, at a computer system, a declarative specification for a datacenter on a cloud platform where the datacenter includes a hierarchy of datacenter entities and services, and where the declarative specification describes dependencies between particular datacenter entities and combinations of one or more services required for execution of the particular datacenter entities.

Method 1400 continues at block 1420 by generating an aggregate pipeline for the datacenter based on the declarative specification where the aggregate pipeline includes a hierarchy of pipelines for datacenter entities of the datacenter, at least some of the pipelines being datacenter entity pipelines for individual datacenter entities and where a datacenter entity pipeline include stages for deployment of the individual datacenter entity associated with the datacenter entity pipeline.

At block 1430, method 1400 proceeds by placing retry stages at ends of the datacenter entity pipelines where a retry stage in a datacenter entity pipeline is configured to invoke a retry strategy for the datacenter entity pipeline in response to a failure in execution of a particular stage in the datacenter entity pipeline and where the retry strategy for the datacenter entity pipeline is invoked starting at the particular stage that failed.

At block 1440, method 1400 proceeds by executing the aggregate pipeline for the datacenter on the cloud platform according to the declarative specification.

### APPENDIX A—ORCHESTRATION WORKFLOW AND DATACENTER BUILD EXECUTION EXAMPLE EMBODIMENTS

FIG. 15 is a block diagram of a system environment for a multi-tenant system with datacenters on cloud platforms, according to some embodiments. In the illustrated embodiment, system environment 1500 includes multi-tenant system 1510, one or more cloud platforms 1520, and one or more client devices 1505. Various embodiments may be contemplated where system environment 100 has more or less components. Multi-tenant system 1510 may store information for one or more tenants 1515. Each tenant may be associated with an enterprise that represents a customer of multi-tenant system 1510. Any of tenants 1515 may have multiple users that interact with multi-tenant system 1510 via client devices 1505.

A tenant 1515 may create one or more datacenters 1525 on cloud platform 1520. Tenants 1515 may offer different functionality to users of the tenants. Accordingly, tenants 1515 may execute different services on datacenters 1525 configured for the tenants. The multi-tenant system 1510 may implement different mechanisms for release and deployment of software for each tenant. A tenant 1515 may further obtain or develop versions of software that include instructions for various services executing in a datacenter 1525. Embodiments allow the tenant 1515 to deploy specific versions of software releases for different services running on different computing resources of the datacenter 1525.

In various embodiments, the computing resources of a datacenter 1525 are secure and may not be accessed by users that are not authorized to access them. For example, a datacenter 1525a that is created for users of tenant 1515a may not be accessed by users of tenant 1515b unless access is explicitly granted. Similarly, datacenter 1525b that is created for users of tenant 1515b may not be accessed by users of tenant 1515a, unless access is explicitly granted. Furthermore, services provided by a datacenter 1525 may be accessed by computing systems outside the datacenter, if access is granted to the computing systems in accordance with the declarative specification of the datacenter.

With the multi-tenant system 1510, data for multiple tenants may be stored in the same physical database. The database may be configured, however, such that data of one tenant is kept logically separate from data for other tenants. Accordingly, one tenant does not have access to another tenant's data unless the data is expressly shared. It is transparent to tenants that their data may be stored in a table that is shared with data of other customers. A database table may store rows for a plurality of tenants. Accordingly, in a multi-tenant system, various elements of hardware and software of the system may be shared by one or more tenants. For example, the multi-tenant system 1510 may execute an application server that simultaneously processes requests for a number of tenants. The multi-tenant system 1510 may, however, enforce tenant-level data isolation to ensure that one tenant cannot access data of other tenants.

Examples of cloud platforms include AWS (AMAZON web services), GOOGLE cloud platform, or MICROSOFT AZURE. A cloud platform 1520 offers computing infrastructure services that may be used on demand by a tenant 1515 or by any computing system external to the cloud platform 1520. Examples of the computing infrastructure services offered by a cloud platform include, but are not limited to, servers, storage, databases, networking, security, load balancing, software, analytics, intelligence, and other infrastructure service functionalities. These infrastructure services may be used by a tenant 1515 to build, deploy, and manage applications in a scalable and secure manner.

The multi-tenant system 1510 may include a tenant data store that stores data for various tenants of the multi-tenant store. The tenant data store may store data for different tenants in separate physical structures, for example, separate database tables or separate databases. Alternatively, the tenant data store may store data of multiple tenants in a shared structure. For example, user accounts for all tenants may share the same database table. However, the multi-tenant system stores additional information to logically separate data of different tenants.

In the illustrated embodiment of FIG. 15, the interactions between the various components of the system environment 1500 are typically performed via a network. In various embodiments, the network uses standard communications technologies and/or protocols. In other embodiments, the entities may use custom and/or dedicated data communications technologies instead of, or in addition to, the ones described above.

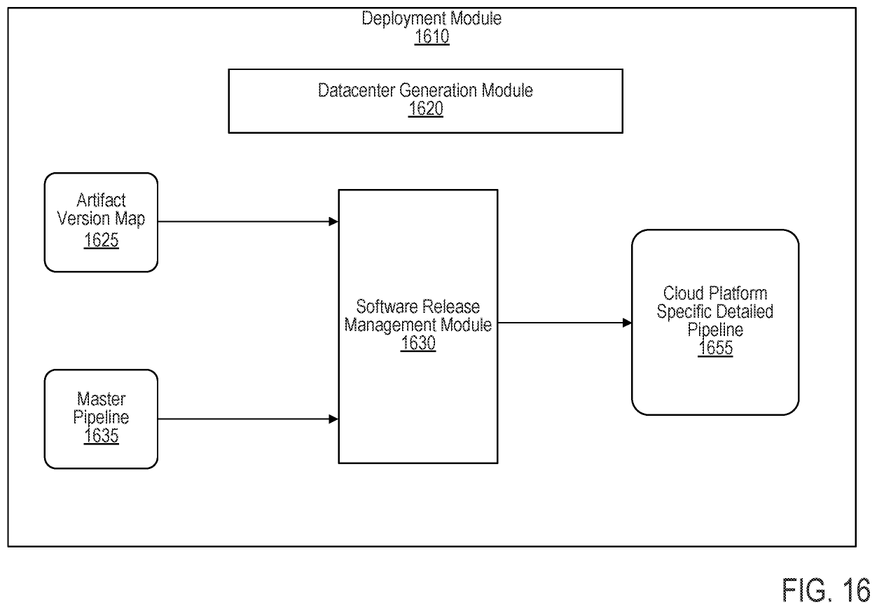

FIG. 16 is a block diagram illustrating system architecture of a deployment module, according some embodiments. Deployment module 1610 may be implemented for deploying software artifacts on the cloud platforms. In some embodiments, deployment module 1610 may perform various operations associated with software releases. For example, deployment module 1610 may provision resources on a cloud platform, deploy software releases, perform rollbacks of software artifacts installed on datacenter entities, etc. In the illustrated embodiment, deployment module 1610 includes datacenter generation module 1620 and software release management module 1630.

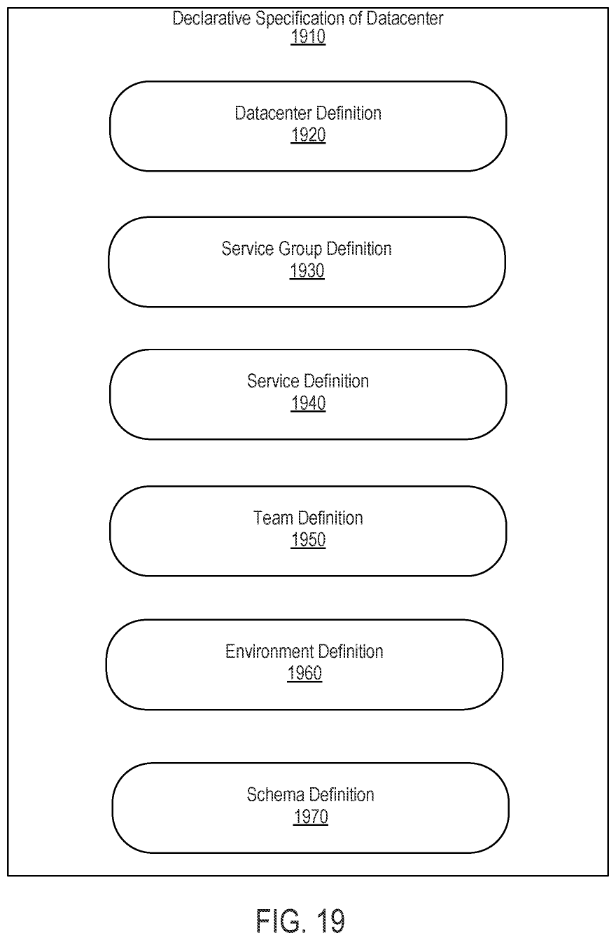

In certain embodiments, datacenter generation module 1620 includes instructions for creating datacenters on the cloud platform. Software release management module 1630 includes instructions for deploying software releases for various services or applications running on the datacenters created by the datacenter generation module 1620. In certain embodiments, datacenter generation module 1620 receives from users (e.g., users of a tenant) a cloud platform independent declarative specification of a datacenter. FIG. 19, described below, describes various types of datacenter entities in further detail. Datacenter generation module 1620 receives the declarative specification and a target cloud platform as input and generates a cloud platform specific metadata representation for the target cloud platform. In various embodiments, as described herein, datacenter generation module 1620 deploys the generated cloud platform specific metadata representation on the target cloud platform to create a datacenter on the target cloud platform according to the declarative specification.

In certain embodiments, software release management module 1630 receives as inputs (1) an artifact version map 1625 (e.g., a deployment manifest) and (2) a master pipeline 1635. The artifact version map 1625 identifies specific versions of software releases or deployment artifacts that are targeted for deployment on specific datacenter entities. The artifact version map 1625 maps datacenter entities to software release versions that are targeted to be deployed on the datacenter entities. The master pipeline 1635 includes instructions for operations related to software releases on the datacenter. For example, master pipeline 1635 may include instructions for deployment of services, destroying services, provisioning resources for services, destroying resources for services, etc.

In various embodiments, master pipeline 1635 may include instructions for performing operations related to software releases for different environments such as development environment, test environment, canary environment, and production environment, and instructions for determining when a software release is promoted from one environment to another environment. For example, if the deployments of a software release in a development environment execute more than a threshold number of test cases, the software release is promoted for test environment for further testing, for example, system level and integration testing. If the software release in a test environment passes a threshold of test coverage, the software release is promoted to canary environment where the software release is provided to a small subset of users on a trial basis. If the software release in a canary environment executes without errors for a threshold time, the software release is promoted to production environment where the software release is provided to all users.

In some embodiments, software release management module 1630 compiles the input artifact version map 1625 and the master pipeline 1635 to generate a cloud platform specific detailed pipeline 1655 that is transmitted to the target cloud platform. The cloud platform specific detailed pipeline 1655 includes instructions for deploying the appropriate version of a software release or deployment artifact on the datacenter entities as specified in the artifact version map 1625. The software release management module 1630 may receive modifications to one of the inputs. For example, a user may modify the input artifact version map 1625 and provide the same master pipeline 1635. Accordingly, the same master pipeline is being used but different software releases are being deployed on datacenter entities. The software release management module 1630 recompiles the inputs to generate a new cloud platform specific detailed pipeline 1655 that deploys the versions of software releases according to the new artifact version map 1625.

As described herein, artifact version map 1625 may also be referred to as a deployment manifest (e.g., deployment manifest 322), a version manifest, a software release map, or a software artifact version map. Master pipeline 1635 may also be referred to as a master deployment pipeline or a master orchestration pipeline. The master pipeline is an aggregate pipeline comprising a hierarchy of pipelines as shown in FIG A7. A master pipeline may contain multiple aggregate pipelines representing multiple datacenter entities. The artifact version manifest or deployment manifest specifies information specific to a datacenter entity, for example, a particular software artifact version that should be used for the datacenter entity, values of parameters provided as input to a pipeline for that datacenter entity, types of computing resources to be used for that datacenter entity, specific parameter values for configuration of the computing resources for the datacenter entity, etc.

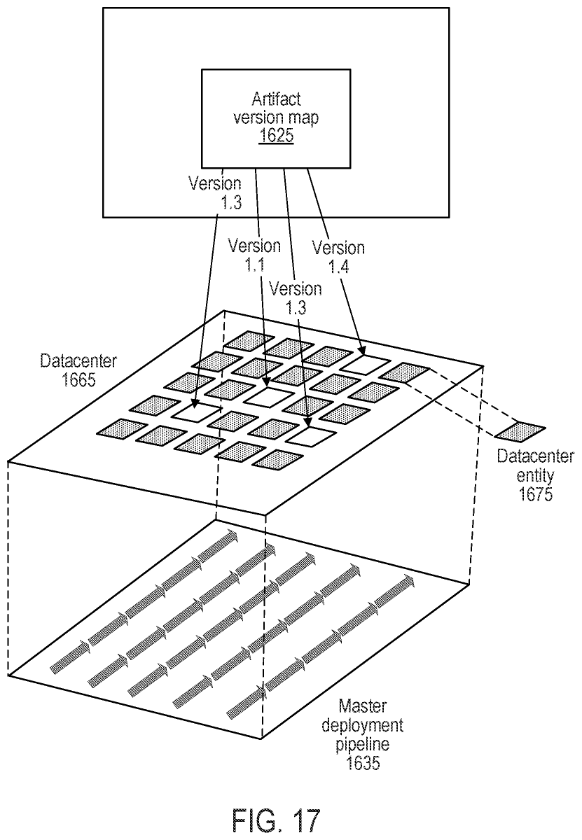

FIG. 17 illustrates an example overall process for deploying software artifacts in a datacenter, according to some embodiments. The illustrated embodiment includes a layout of datacenter 1665 including various datacenter entities. Artifact version map 1625 identifies different versions of software that are targeted for release on different datacenter entities 1675 of datacenter 1665. Master deployment pipeline 1635 represents the flow of deployment artifacts through the various environments of the datacenter. The software release management module 1630 combines the information in the master pipeline 1635 with the artifact version map 1625 to determine cloud platform specific detailed pipeline 1655 that maps the appropriate version of software artifacts on the datacenter entities according to the artifact version map 1625.

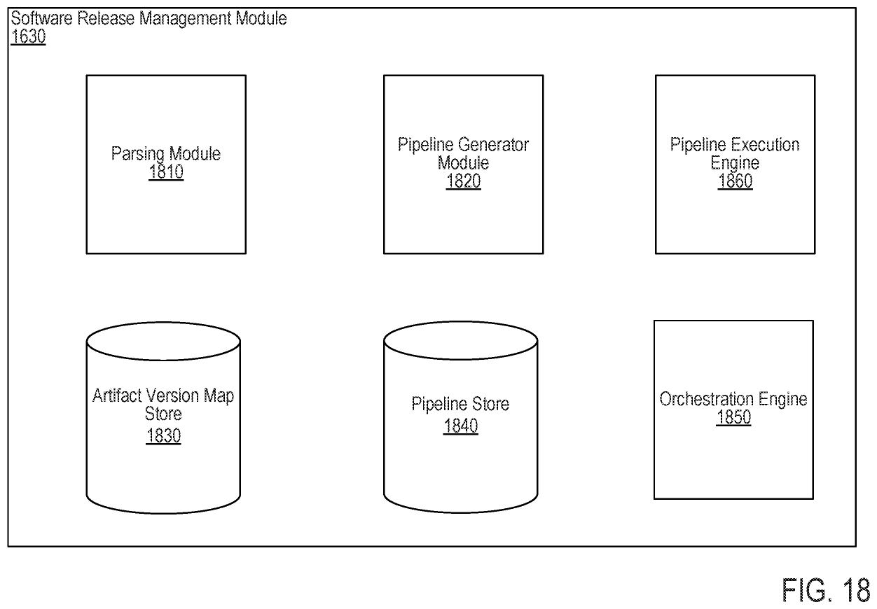

FIG. 18 is a block diagram of software release management module 1630, according to some embodiments. In the illustrated embodiment, software release management module 1630 includes parsing module 1810, pipeline generator module 1820, artifact version map store 1830, pipeline store 1840, and pipeline execution engine 1860. Parsing module 1810 parses various types of user input including the declarative specification of a datacenter, artifact version map 1625, and master pipeline 1635. Parsing module 1810 generates data structures and metadata representations of the input processed and provides the generated data structures and metadata representations to other modules of the software release management module 1630 for further processing.

Metadata store 1840 stores various transformed metadata representations of datacenters that are generated by software release management module 1630. The transformed metadata representations may be used for performing rollback to a previous version if an issue is encountered in a current version of the datacenter. The transformed metadata representations may be used for validation, auditing, and governance at various stages of the transformation process.

In various embodiments, pipeline generator module 1820 processes the master pipelines in conjunction with the artifact version map received as input to generate a detailed pipeline for a target cloud platform. The pipelines include stages that include instructions for provisioning services or deploying applications for deploying versions of software releases for various services on the cloud platform according to the artifact version map. The artifact version map store 1830 stores artifact version maps received from users and the pipeline store 1840 stores master pipelines as well as pipelines generated by the pipeline generator module 1820.

Pipeline execution engine 1860 executes the detailed pipelines generated by the pipeline generator module 1820. In one contemplated embodiment, the pipeline execution engine 1860 is a system such as SPINNAKER that executes pipelines for releasing/deploying software. Pipeline execution engine 1860 parses the pipelines and executes each stage of the pipeline on a target cloud computing platform.

In various embodiments, orchestration engine 1850 performs orchestration of the operations related to datacenters or datacenter entities on the cloud platforms including building, destruction, and modification of the datacenters or datacenter entities. The orchestration engine 350 processes the declarative specification of a datacenter and uses the layout of the datacenter as defined by the declarative specification to generate pipelines for orchestration of operations associated with the datacenter. Processes executed by the orchestration engine 1850 are further described herein.

FIG. 19 illustrates an example of a declarative specification of a datacenter, according to some embodiments. In the illustrated embodiment, declarative specification 1910 includes multiple datacenter entities. A datacenter entity is an instance of a datacenter entity type and there can be multiple instances of each datacenter entity type. Examples of datacenter entities include, but are not limited to, datacenters, service groups, services, teams, environments, and schemas.

In various embodiments, declarative specification 1910 includes definitions of various types of datacenter entities including service group, service, team, environment, and schema. Declarative specification 1910 may include one or more instances of datacenters. Following is a description of examples of the various types of datacenter entities and their examples. The examples are illustrative and show some of the attributes of the datacenter entities. Other embodiments may include different attributes and an attribute with the same functionality may be given a different name than that indicated herein. In an embodiment, the declarative specification is specified using hierarchical objects, for example, JSON (Javascript object notation) that conform to a predefined schema.

In some embodiments, a service group 1930 represents a set of capabilities and features and services offered by one or more computing systems that can be built and delivered independently. A service group may be also referred to as a logical service group, a functional unit, a business unit, or a bounded context. Service group 1930 may also be viewed as a set of services of a set of cohesive technical use-case functionalities offered by one or more computing systems. Service group 1930 may enforce security boundaries or define a scope for modifications. Thus, any modifications to an entity, such as a capability, feature, or service offered by one or more computing systems within a service group 1930 may propagate as needed or suitable to entities within the service group, but does not propagate to an entity residing outside the bounded definition of the service group 1930. A datacenter may include multiple service groups 1930. A service group definition specifies attributes including a name, description, an identifier, schema version, and a set of service instances. An example of a service group is a blockchain service group that includes a set of services used to providing blockchain functionality. Similarly, a security service group provides security features. A user interface service group provides functionality of specific user interface features. A shared document service group provides functionality of sharing documents across users. Similarly, there can be several other service groups.

Service groups support reusability of a declarative specification such that tenants or users interested in developing a datacenter have a library of service groups that they can readily use. The boundaries around services of a service groups are based on security concerns and network concerns among others. A service group is associated with protocols for performing interactions with the service group. In an embodiment, a service group provides a collection of APIs (application programming interfaces) and services that implement those APIs. Furthermore, service groups are substrate independent. A service group provides a blast radius scope for the services within the service group so that any failure of a service within the service group has impact limited to services within the service group and has minimal impact outside the service group.

In various embodiments, service definition 1940 specifies metadata for a type of service. For example, metadata for a database service or a load balancer service. The metadata may describe various attributes of a service including a name of the service, description of the service, location of documentation for the service, any sub-services associated with the service, an owner for the service, a team associated with the service, build dependencies for the service specifying other services on which this service depends at build time, start dependencies of the service specifying the other services that should be running when this particular service is started, authorized clients, DNS (domain name server) name associated with the service, a service status, a support level for the service, etc. In some embodiments, service definition 1940 specifies a listening ports attribute specifying the ports that the service can listen on for different communication protocols.

In various embodiments, service definition 1940 specifies an attribute outbound access that specifies destination endpoints such as external URLs (uniform resource locators) specifying that the service needs access to the specified external URLs. During deployment, the datacenter generation module ensures that the cloud platform implements access policies such that instances of this service type are provided with the requested access to the external URLs. The outbound access specification may identify one or more environment types for the service for which the outbound access is applicable. For example, an outbound access for a first set of endpoints may apply to a particular environment and outbound access for a second set of endpoints may apply to another environment.

In various embodiments, team definition 1950 includes team member names and other attributes of a team for example, name, email, and communication channel. As an example of a team definition, a service may be associated with one or more teams that are responsible to modifications made to that service. Accordingly, any modification made to that service is approved by the team. A service may be associated with a team responsible for maintenance of the service after it is deployed in a cloud platform. A team may be associated with a service group and is correspondingly associated with all services of that service group. For example, the team approves any changes to the service group, for example, services that are part of the service group. A team may be associated with a datacenter and is accordingly associated with all service groups within the datacenter. A team association specified at a datacenter level provides a default team for all the service groups within the datacenter and further provides a default team for all services within the service groups.

In some embodiments, a team association specified at the functional level overrides the team association provided at the datacenter level. Similarly, a team association specified at the service level overrides the default that may have been provided by a team association specified at the service group level or a datacenter level. A team can decide how certain action is taken for the datacenter entity associated with the team. The team associations also determine the number of accounts on the cloud platform that are created for generating the final metadata representation of the datacenter for a cloud platform by the compiler and for provisioning and deploying the datacenter on a cloud platform. The datacenter generation module 1610 creates one or more user accounts in the cloud platform and provides access to the team members to the user accounts. Accordingly, the team members are allowed to perform specific actions associated with the datacenter entity associated with the team, for example, making or approving structural changes to the datacenter entity or maintenance of the datacenter entity when it is deployed including debugging and testing issues that may be identified for the datacenter entity.

In various embodiments, environment definition 1960 specifies a type of system environment represented by the datacenter. For example, the system environment may be a development environment, a staging environment, a test environment, or a production environment. A schema definition 1970 may specify schema that specifies syntax of specific datacenter entity definitions. The schema definition 1970 is used for validating various datacenter entity definitions. The datacenter generation module determines security policies for the datacenter in the cloud platform specific metadata representation based on the environment. For example, a first set of security policies may be applicable for a first environment and a second set of security policies may be applicable for a second environment. In some embodiments, the security policies provide much more restricted access in a production environment as compared to a development environment. The security policy may specify the length of time that a security token is allowed to exist for specific purposes.

In certain embodiments, a datacenter definition 1920 specifies the attributes and components of a datacenter instance. Datacenter definition 1920 may specify attributes including a name, description, a type of environment, a set of service groups, teams, domain name servers for the datacenter, etc. A datacenter definition may specify a schema definition and any metadata representation generated from the datacenter definition is validated against the specified schema definition. A datacenter includes a set of core services and capabilities that enable other services to function within the datacenter. An instance of a datacenter is deployed in a particular cloud platform and may be associated with a particular environment type, for example, development, testing, staging, production, etc.

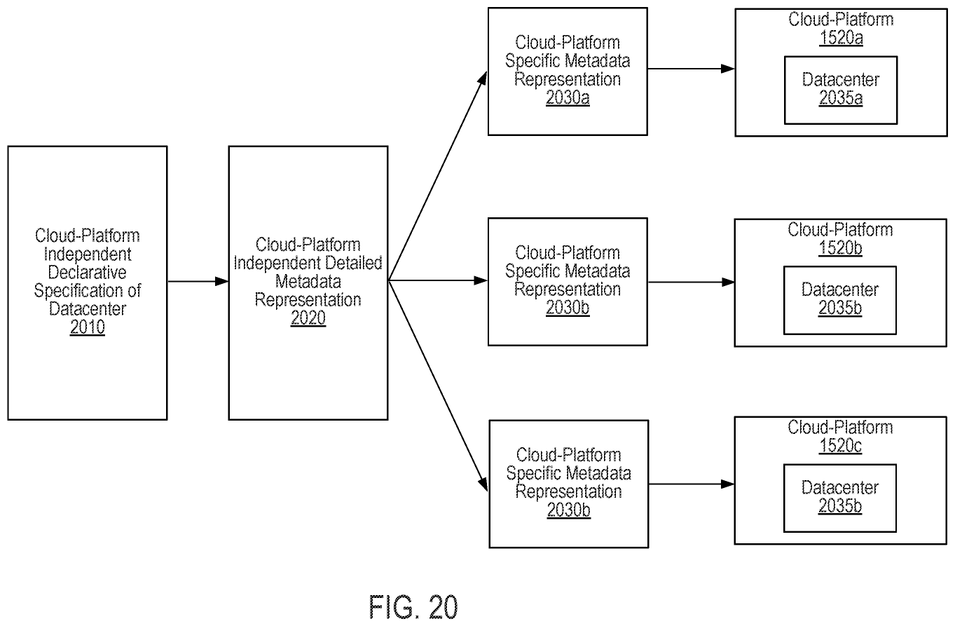

FIG. 20 is a block diagram illustrating generation of datacenters on cloud platforms based on a platform independent declarative specification, according to some embodiments. Datacenter generation may be implemented by deployment module 1610, described above, or any other module implemented to execute an orchestration workflow described herein. In various embodiments, cloud-platform independent declarative specification 2010 is received as input. The cloud-platform independent declarative specification 2010 may be a version of the declarative specification that is being incrementally modified by users. Since cloud-platform independent declarative specification 2010 is not specified for any specific target cloud platform, a datacenter may be configured on any target cloud platform based on the cloud-platform independent declarative specification 2010.

In certain embodiments, cloud-platform independent declarative specification 2010 is processed to generate cloud-platform independent detailed metadata representation 2020 for the datacenter. The cloud-platform independent detailed metadata representation 2020 defines details of each instance of a datacenter entity specified in the cloud-platform independent declarative specification 2010. Unique identifiers may be created for datacenter entity instances (e.g., service instances). In some embodiments, the cloud-platform independent detailed metadata representation 2020 includes an array of instances of datacenter entity types, for example, an array of service group instances of a particular service group type. Service group instances may include arrays of service instances. A service instance may further include the details of a team of users that are allowed to perform certain actions associated with the service instance. The details of the team are used during provisioning and deployment. For example, the details may be used for creating a user account for the service instance and allowing members of the team to access the user account.

In various embodiments, cloud-platform independent detailed metadata representation 2020 includes attributes of each instance of datacenter entity. Accordingly, the description of each instance of a datacenter entity is expanded to include all details. In some embodiments, the cloud-platform independent detailed metadata representation 2020 is immutable (e.g., once the representation is finalized, no modifications are performed to the representation). For example, if any updates, deletes, or additions of datacenter entities need to be performed, they are performed on the cloud platform independent declarative specification 2010 rather than cloud-platform independent detailed metadata representation 2020.

In certain embodiments, a target cloud platform on which the datacenter is expected to be provisioned and deployed is received and a cloud platform specific detailed metadata representation 2030 of the datacenter is generated. For example, interfacing with the target cloud platform may be implemented to generate certain entities (or resources), for example, user accounts, virtual private clouds (VPCs), and networking resources such as subnets on the VPCs, various connections between entities in the cloud platform, etc. Resource identifiers of resources that are to be created in the target cloud platform (for example, user account names, VPC IDs, etc.) may be received and incorporated in the cloud-platform independent detailed metadata representation 2020 to obtain the cloud platform specific metadata representation 2030 of the datacenter.

A target cloud platform may perform several steps to process the cloud-platform specific detailed metadata representation 2030. For example, the cloud platform independent declarative specification 2020 may specify permitted interactions between services. These permitted interactions are specified in the cloud-platform specific detailed metadata representation 2030 and implemented as network policies of the cloud platform. The cloud platform may further create security groups to implement network strategies to implement the datacenter according to the declarative specification.

The cloud platform independent declarative specification 2010 specifies dependencies between services. For example, as described herein, start dependencies for each service listing all services that should be running when a particular service is started may be specified in the declarative specification. The cloud platform specific detailed metadata representation 2030 of the datacenter may include information describing these dependencies. As described herein, in certain embodiments, the execution of an orchestration workflow (e.g., execution and deployment of a datacenter build) does not begin until all start dependencies are up and running. Accordingly, the services required to be started before the service are running when the service is started.

In various embodiments, the cloud platform specific metadata representation 2030 is deployed on the specific target cloud platform for which the representation was generated to place the specified datacenter on the target cloud platform. For example, datacenter 2035a is placed on cloud platform 1520a according to cloud platform specific metadata representation 2030a, datacenter 2035b is placed on cloud platform 1520b according to cloud platform specific metadata representation 2030b, and datacenter 2035c is placed on cloud platform 1520c according to cloud platform specific metadata representation 2030c. Various validations may be performed using the generated metadata representations, including policy validations, format validations, etc. to validate the datacenter builds on the cloud platforms.

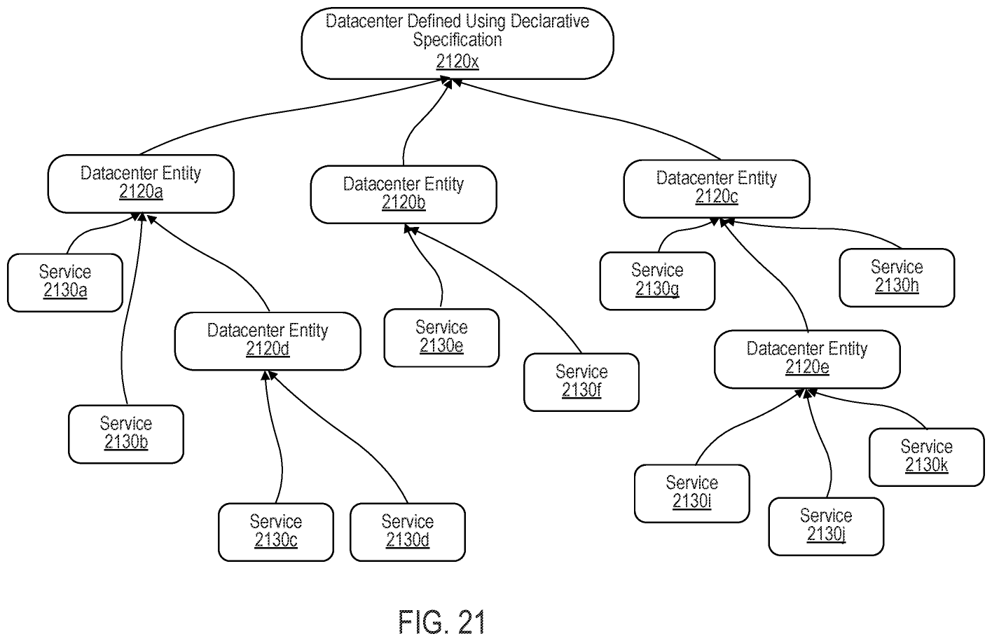

FIG. 21 shows an example datacenter configuration as specified using a declarative specification, according to some embodiments. The root node 2120x represents the datacenter defined by the declarative specification that includes a hierarchy of datacenter entities. The datacenter entities 2120a, 2120b, 2120c, 2120d, 2120e may represent service groups (e.g., functional domains). A datacenter entity representing a service group may include one or more services. For example, datacenter entity 2120d may include services 2130c and 2130d, datacenter entity 2120e may include services 2130i, 2130j, and 2130k, and datacenter entity 2120b may include services 2130e, and 2130f. A datacenter entity may include services as well as other datacenter entities. For example, datacenter entity 2120a includes services 2130a, 2130b, and datacenter entity 2120d while datacenter entity 2120c includes services 2130g, 2130h, and datacenter entity 2120e. The system uses the declarative specification to determine the layout of the datacenter (e.g., as a blueprint of the datacenter) being created to guide the process of orchestration of the workflow for the datacenter. For example, the system may create pipelines for building of datacenter entities and for building of individual services based on the declarative specification, as described herein.

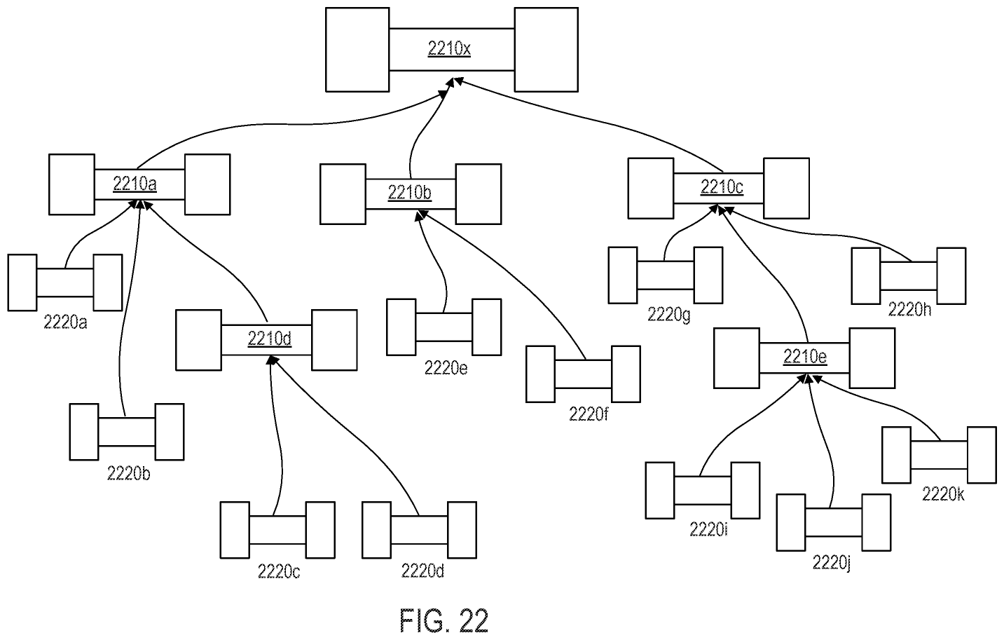

FIG. 22 shows an example aggregate pipeline generated for creating a datacenter based on a declarative specification, according to some embodiments. In the illustrated embodiment, an aggregate pipeline is shown that represents a hierarchy of pipelines that corresponds to the hierarchy of datacenter entities defined in the declarative specification of FIG. 21. The pipeline structure shown in FIG. 22 includes a pipeline corresponding to each datacenter entity of the datacenter specified by the declarative specification. The system receives information identifying pipelines for individual services from service owners. For example, the service owner may either provide the pipeline for the service or provide a link to a location where the pipeline is stored. The pipelines for services received from the service owners may also be referred to as unit pipelines. For example, the pipelines 2220a, 2220b, 2220c, etc. are unit pipelines for individual services. Each unit pipeline may be executed to configure the corresponding service on the cloud platform. The system generates aggregate pipelines 2210 that group individual service pipelines. For example, aggregate pipeline 2210a corresponds to datacenter entity 2110a, aggregate pipeline 2210b corresponds to datacenter entity 2110b, aggregate pipeline 2210d corresponds to datacenter entity 2110d, and so on. The system generates an aggregate pipeline 2210x for the entire datacenter 2120x. When all services and datacenter entities under a parent datacenter entity are configured (for example, the services are configured and running) the parent datacenter entity gets configured. A pipeline that is not a leaf level pipeline and has one or more child pipeline is an aggregate pipeline that orchestrates executions of the child pipelines.

As described above, the pipeline for the datacenter may be referred to as a master pipeline. The master pipeline is a hierarchical pipeline where each stage of a pipeline may comprise a pipeline with detailed instructions for executing the stage. The master pipeline hierarchy may mirror the datacenter hierarchy. For example, the top level of the master pipeline represents a sequence of stages for different environments. Each environment may include one or more pipelines for datacenter instances or pipelines for other types of datacenter entities. A datacenter instance pipeline may include service group pipelines. Each service group pipeline may include one or more service pipelines. A datacenter instance pipeline may include one or more service pipelines. The service pipeline may comprise stages with each stage in a pipeline representing instructions for deploying the service for specific environments. The lowest level pipeline or the leaf level pipeline in the hierarchy may be referred to as a unit pipeline and may include detailed service specific instructions for performing an operation related to a service. For example, deployment for a service may include pre-deployment steps, deployment steps, post deployment steps, and post deployment test and validation step. A pipeline that is not a leaf level pipeline and has one or more child pipeline is an aggregate pipeline that orchestrates executions of the child pipelines.

In various embodiments, a service master pipeline is created for each service. These pipelines get triggered when a pull request is received for a repository of the software. Pipeline templates may be received from service owners for specific services. These pipeline templates include detailed instructions for testing, validation, build, etc. for specific services. A pipeline generator may create all pipelines for each datacenter from the templates and combine them, via master pipelines, in a hierarchical fashion. In some embodiments, the pipeline generator generates service pipelines for individual services, service group master pipelines to invoke service pipelines, or datacenter instance master pipelines to invoke service group pipelines.

### Example Computer System

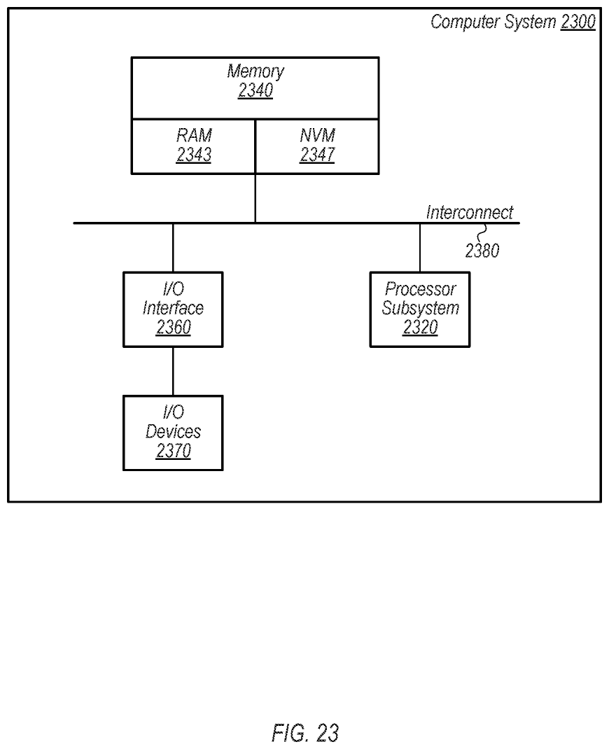

FIG. 23 illustrates a block diagram of an example computer system 2300, which may implement system 100. Computer system 2300 includes processor subsystem 2320 that is coupled to system memory 2340 and I/O interfaces(s) 2360 via interconnect 2380 (e.g., a system bus). I/O interface(s) 2360 is coupled to one or more I/O devices 2370. Computer system 2300 may be any of various types of devices, including, but not limited to, a server computer system, personal computer system, desktop computer, laptop or notebook computer, mainframe computer system, server computer system operating in a datacenter facility, tablet computer, handheld computer, smartphone, workstation, network computer, etc. Although a single computer system 2300 is shown in FIG. 23 for convenience, computer system 2300 may also be implemented as two or more computer systems operating together.

Processor subsystem 2320 may include one or more processors or processing units. In various embodiments of computer system 2300, multiple instances of processor subsystem 2320 may be coupled to interconnect 2380. In various embodiments, processor subsystem 2320 (or each processor unit within 2320) may contain a cache or other form of on-board memory.

System memory 2340 is usable to store program instructions executable by processor subsystem 2320 to cause system 2300 to perform various operations described herein. System memory 2340 may be implemented, as shown, using random access memory (RAM) 2343 and non-volatile memory (NVM) 2347. Furthermore, RAM 2343 may be implemented using any suitable type of RAM circuits, such as various types of static RAM (SRAM) and/or dynamic RAM (DRAM). NVM 2347 may include one or more types of non-volatile memory circuits, including for example, hard disk storage, solid-state disk storage, floppy disk storage, optical disk storage, flash memory, read-only memory (PROM, EEPROM, etc.), and the like. Memory in computer system 2300 is not limited to primary storage such as system memory 2340. Rather, computer system 2300 may also include other forms of storage such as cache memory in processor subsystem 2320, and secondary storage coupled via I/O devices 2370 such as a USB drive, network accessible storage (NAS), etc. In some embodiments, these other forms of storage may also store program instructions executable by processor subsystem 2320. In some embodiments, program instructions that when executed implement orchestration engine 110 may be included/stored within system memory 2340.

I/O interfaces 2360 may be any of various types of interfaces configured to couple to and communicate with other devices, according to various embodiments. In one embodiment, I/O interface 2360 is a bridge chip (e.g., Southbridge) from a front-side to one or more back-side buses. I/O interfaces 2360 may be coupled to one or more I/O devices 2370 via one or more corresponding buses or other interfaces. Examples of I/O devices 2370 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 2370 includes a network interface device (e.g., configured to communicate over WiFi, Bluetooth, Ethernet, etc.), and computer system 2300 is coupled to a network via the network interface device.

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
accessing, by a computer system, a declarative specification for a datacenter on a cloud platform, wherein the datacenter includes a hierarchy of datacenter entities, and wherein the declarative specification describes dependencies between datacenter entities required for execution of particular datacenter entities;
generating an aggregate pipeline for the datacenter based on the declarative specification, wherein the aggregate pipeline includes a hierarchy of pipelines for datacenter entities of the datacenter, at least some of the pipelines being datacenter entity pipelines for individual datacenter entities, and wherein a datacenter entity pipeline include stages for deployment of the individual datacenter entity associated with the datacenter entity pipeline;
placing retry stages at ends of the datacenter entity pipelines, wherein a retry stage in a datacenter entity pipeline is configured to invoke a retry strategy for the datacenter entity pipeline in response to a failure in execution of a particular stage in the datacenter entity pipeline, and wherein the retry strategy for the datacenter entity pipeline is invoked starting at the particular stage that failed; and
executing the aggregate pipeline for the datacenter on the cloud platform according to the declarative specification.

2. The method of claim 1, wherein the retry strategy for a particular datacenter entity pipeline is defined by an owner of the individual datacenter entity associated with the particular datacenter entity pipeline.

3. The method of claim 1, wherein the retry stages are operable to be enabled or disabled by an operator of the computer system.

4. The method of claim 1, wherein the stages in the datacenter entity pipeline include instructions for deployment of the individual datacenter entity on the cloud platform.

5. The method of claim 1, wherein the stages in the datacenter entity pipeline include at least one provision stage and at least one deploy stage, and wherein the particular stage for which the retry strategy for the datacenter entity pipeline is invoked is a provision stage or a deploy stage.

6. The method of claim 5, further comprising placing at least one conditional expression in the provision stage and in the deploy stage, wherein the conditional expression includes instructions not to rerun the stage during a retry when the stage has already been successfully run or any stage positioned before the stage in the datacenter entity pipeline has failed.

7. The method of claim 1, wherein the retry stage in the datacenter entity pipeline is configured to invoke the retry strategy for the datacenter entity pipeline agnostically of retry strategies in other datacenter entity pipelines.

8. The method of claim 1, wherein the aggregate pipeline includes at least a first datacenter entity pipeline with a first retry stage and a second datacenter entity pipeline with a second retry stage, the first retry stage being invoked in response to a failure in execution of the first datacenter entity pipeline and the second retry stage being invoked in response to a failure in execution of the second datacenter entity pipeline, and wherein the first retry stage and the second retry stage are capable of being invoked in parallel.

9. The method of claim 1, wherein the declarative specification is a cloud platform independent declarative specification, and wherein executing the aggregate pipeline for the datacenter includes building datacenter entities for the datacenter, destroying datacenter entities for the datacenter, or updating datacenter entities for the datacenter.

10. The method of claim 1, further comprising:
generating a deployment manifest associating the datacenter entities of the datacenter with versions of software artifacts targeted for deployment on the datacenter entities, wherein a software artifact is associated with a datacenter entity of the datacenter; and
executing the aggregate pipeline in conjunction with the deployment manifest for the datacenter on the cloud platform according to the declarative specification.

11. A non-transitory computer readable medium having program instructions stored thereon that are executable by a computer system to cause the computer system to perform operations comprising:
receiving a request for orchestration of a datacenter on a cloud platform;
accessing a declarative specification for a datacenter on a cloud platform, wherein the datacenter includes a hierarchy of datacenter entities, and wherein the declarative specification describes dependencies between datacenter entities required for execution of particular datacenter entities;
generating an aggregate pipeline for the datacenter based on the declarative specification, wherein the aggregate pipeline includes a hierarchy of pipelines for datacenter entities of the datacenter, at least some of the pipelines being datacenter entity pipelines for individual datacenter entities, and wherein a datacenter entity pipeline include stages for deployment of the individual datacenter entity associated with the datacenter entity pipeline;
locating retry stages at ends of the datacenter entity pipelines, wherein a retry stage in a datacenter entity pipeline is configured to invoke a retry strategy for the datacenter entity pipeline in response to a failure in execution of a particular stage in the datacenter entity pipeline, and wherein the retry strategy for the datacenter entity pipeline is invoked starting at the particular stage that failed;
generating a deployment manifest associating the datacenter entities of the datacenter with versions of software artifacts targeted for deployment on the datacenter entities, wherein a software artifact is associated with a datacenter entity of the datacenter; and
executing the aggregate pipeline in conjunction with the deployment manifest for orchestration of the datacenter on the cloud platform according to the declarative specification.

12. The non-transitory computer readable medium of claim 11, wherein the retry strategy includes at least one conditional expression that is satisfied for execution of a retry of the stage.

13. The non-transitory computer readable medium of claim 11, wherein the retry strategy includes at least one conditional expression that assesses whether the stage has been run successfully during a prior execution of the datacenter entity pipeline.

14. The non-transitory computer readable medium of claim 11, wherein the retry strategy includes restarting execution of the datacenter entity pipeline at an earliest stage in the datacenter entity pipeline that has failed.

15. The non-transitory computer readable medium of claim 14, wherein the earliest stage in the datacenter entity pipeline is a deploy stage or a provision stage.

16. The non-transitory computer readable medium of claim 11, wherein the retry strategy includes a maximum number of retries attempts that are allowed before failing the datacenter entity pipeline.

17. A system, comprising:
at least one processor; and
memory having program instructions stored thereon that are executable by the at least one processor to cause the system to perform operations comprising:
accessing a declarative specification for a datacenter on a cloud platform in response to receiving a request to orchestrate the datacenter on the cloud platform, wherein the datacenter includes a hierarchy of datacenter entities, and wherein the declarative specification describes dependencies between datacenter entities required for execution of particular datacenter entities;
generating an aggregate pipeline for the datacenter based on the declarative specification, wherein the aggregate pipeline includes a hierarchy of pipelines for datacenter entities of the datacenter, at least some of the pipelines being datacenter entity pipelines for individual datacenter entities, and wherein a datacenter entity pipeline include stages for deployment of the individual datacenter entity associated with the datacenter entity pipeline;
locating retry stages at ends of the datacenter entity pipelines, wherein a retry stage in a datacenter entity pipeline is configured to invoke a retry strategy for the datacenter entity pipeline in response to a failure in execution of the datacenter entity pipeline, and wherein the retry strategy for the datacenter entity pipeline is invoked starting at an earliest failed stage in the datacenter entity pipeline; and
generating a deployment manifest associating the datacenter entities of the datacenter with versions of software artifacts targeted for deployment on the datacenter entities, wherein a software artifact is associated with a datacenter entity of the datacenter; and
executing the aggregate pipeline in conjunction with the deployment manifest to orchestrate the datacenter on the cloud platform according to the declarative specification.

18. The system of claim 17, wherein the stages in the datacenter entity pipeline include at least one provision stage and at least one deploy stage.

19. The system of claim 17, wherein program instructions include instructions not to rerun a stage during a retry when the stage has already been successfully run.

20. The system of claim 17, wherein program instructions include instructions not to rerun a stage during a retry when any stage before the stage has failed.
